(19) United States
(12) Patent Application Publication
(10) Pub. No.: US 2004/0230500 A1
(43) Pub. Date: Nov. 18, 2004

(54) Service providing apparatus, user terminal, service providing method, service utilizing method, computer-readable recording medium recorded with a service providing program, and computer-readable recording medium recorded with a service utilizing program

(76) Inventor: Satosi Imago, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/781,739

(22) Filed: Feb. 20, 2004

(30) Foreign Application Priority Data
Feb. 21, 2003 (JP) 2003-044589
Feb. 21, 2003 (JP) 2003-044590
Feb. 16, 2004 (JP) 2004-038540
Feb. 16, 2004 (JP) 2004-038541

(51) Int. Cl. G06F 17/60

(52) U.S. Cl. 705/27

(57) ABSTRACT

In a service information providing apparatus including a service providing part for providing a service which a user utilizes, the service providing part includes a service information providing part providing information concerning the service in that the information is utilized when the user selects the service, in response to a request from a user terminal.

### BACKGROUND OF THE INVENTION

1. Field of the Invention

The present invention generally relates to a service providing apparatus, a user terminal, a service providing method, a service utilizing method, a computer-readable recoding medium recorded with a service providing program, and a computer-readable recording medium recorded with a service utilizing program.

2. Description of the Related Art

Conventionally, a service discovering method disclosed by the Japanese Laid-Open Patent Application No. 2000-209231 is known to discover a service provided by each device connected to the Network.

However, the conventional method described above has disadvantages in that information needed when a user selects one service is not provided to the user even if a service is discovered.

FIG. 1 is a diagram for explaining the disadvantages of the conventional technology (part 1). In FIG. 1, a client terminal and each of server A, B, and C are connected through a network.

In step S1, the client terminal sends a request of a search for a service A to the servers A, B, and C by using a multi-cast.

In step S2 following to the step S1, the client terminal, the server A having the service A and the server B having the service A send the client terminal a search response showing that the service A is available to provide.

The client terminal can discover the service A by obtaining the search response. However, the search response does not include information needed when a user using the client terminal selects the service A.

For example, in a case in that the service A is a print service and the user attempts to conduct a color print, the search response dos not include detailed information of the print service. Thus, the user can not determine which print service can conduct the color print.

In practice, in the conventional technology shown in FIG. 1, in step S3 following to the step S2, the client terminal sent an obtaining request for obtaining the detailed information of the service A to both the server A and the server B providing the service A.

In step S4 following to the step S3, each of the server A and the server B sends an obtaining response including the detailed information of the service A with respect to the obtaining response to the client terminal.

The client terminal can finally obtain the detailed information of each service A by receiving the obtaining response, and then, the user can select and utilize the service A provided by the server A or the server B.

In FIG. 1, the method for sending the search request of the service A by the multi-cast to the server A, the server B, and the server C is described in order for the client terminal to discover the service A. Alternatively, another method to discover the service A is a method in that the client terminal sends an obtaining request for obtaining a list of services to each of the servers A, B, and C.

FIG. 2 is a diagram for explaining the disadvantages of the conventional technology (part 2). In FIG. 2, the client terminal and each of the servers A, B, and C are connected through the network.

In step S5, the client terminal sends the obtaining request for obtaining the list of services to the servers A, B, and C.

In step S6 following to the step S5, each of the servers A, B, and C generates the list of services provided by themselves, and sends the obtaining response including the list of services to the client terminal.

The client terminal can discover the service A by obtaining the obtaining response including the list of services from each of servers A, B, and C.

However, similar to the above-described method, disadvantageously, there is a problem in that the obtaining response including the list of services does not include information needed when the use of the client terminal selects the service A.

In practice, in the conventional technology shown in FIG. 2, in step S7 following to the step S6, the client terminal sends the obtaining request for obtaining the detailed information of the service A to the servers A and B, respectively.

In step S8 following to the step S7, each of the services A and B sends the obtaining response including the detailed information of the service A provided by themselves with respect to the obtaining request.

As described above, the client terminal can finally obtain the detailed information of each of the services A of the servers A and B. Then, the user can select and utilize the service A provided by the server A or the server B.

### SUMMARY OF THE INVENTION

It is a general object of the present invention to provide a service providing apparatus, a user terminal, a service providing method, a service utilizing method, a computer-readable recoding medium recorded with a service providing program, and a computer-readable recording medium recorded with a service utilizing program, in which the above-mentioned problems are eliminated.

A more specific object of the present invention is to promptly provide information needed when the user selects a service desired by the user.

Another specific object of the present invention is to promptly obtain information needed when the user selects the service desired by the user.

The above objects of the present invention are achieved by a service information providing apparatus including a service providing part for providing a service which a user utilizes, wherein the service providing part includes a service information providing part providing information concerning the service, the information utilized when the user selects the service, in response to a request from a user terminal.

According to the present invention, it is possible to promptly provide information needed when a user selects a service desired by the user, to a user terminal use by the user.

The above objects of the present invention are achieved by a user terminal which is to be used by a user who utilizes a service provided by a service providing part, including: a request creating part creating a request including a search condition concerning the service; and a response receiving part receiving a response including information concerning the service, the information utilized when the user selects the service, the response corresponding to the request.

According to the present invention, it is possible to promptly obtain information needed when the user selects the service desired by the user.

The above objects of the present invention are achieved by a service information providing apparatus for providing information concerning a service utilized when a user selects the service, the service information providing apparatus including a managing part managing first information concerning a plurality of service providing parts providing the service and second information concerning the service which is provided the plurality of service providing parts, respectively.

According to the present invention, it is possible to promptly provide information needed when a user selects a service desired by the user, to a user terminal use by the user.

The above objects of the present invention are achieved by a user terminal which a user uses to utilize a service provided by a service providing part, including: a request generating part generating a request including a search condition concerning the service; and a response receiving part receiving a response including information concerning the service, the information utilized when the user selects the service.

According to the present invention, it is possible to promptly obtain information needed when the user selects the service desired by the user.

The above objects of the present invention can be achieved by a computer-readable recording medium recorded with a program and a program for causing a computer to conduct the processes described above.

### BRIEF DESCRIPTION OF THE DRAWINGS

In the following, embodiments of the present invention will be described with reference to the accompanying drawings.

FIG. 1 is a diagram for explaining the disadvantages of the conventional technology (part 1);

FIG. 2 is a diagram for explaining the disadvantages of the conventional technology (part 2);

FIG. 3 is a diagram for explaining a system configuration according to a first embodiment of the present invention;

FIG. 4 is a diagram for explaining another system configuration according to a second embodiment of the present invention;

FIG. 5 is a block diagram showing a functional configuration of the service information providing server according to the first embodiment of the present invention;

FIG. 6 is a block diagram showing a hardware configuration of the service information providing server according to the first embodiment of the present invention;

FIG. 7 is a diagram for explaining functions of the service information providing part according to the first embodiment of the present invention;

FIG. 8 is a block diagram for explaining another functional configuration of the service information providing part according to the first embodiment of the present invention;

FIG. 9 is a diagram for explaining the service information storing part according to the first embodiment of the present invention;

FIG. 10 is a diagram for explaining a first variation of the service information storing part according to the first embodiment of the present invention;

FIG. 11 is a diagram for explaining a second variation of the service information storing part according to the first embodiment of the present invention;

FIG. 12 is a diagram for explaining a third variation of the service information storing part according to the first embodiment of the present invention;

FIG. 13 is a diagram for explaining the request according to the first embodiment of the present invention;

FIG. 14 is a diagram for explaining the response according to the first embodiment of the present invention;

FIG. 15 is a diagram for explaining a first variation of the request according to the first embodiment of the present invention;

FIG. 16 is a diagram for explaining a first variation of the response according to the first embodiment of the present invention;

FIG. 17 is a diagram for explaining a second variation of the response according to the first embodiment of the present invention;

FIG. 18 is a diagram for explaining a third variation of the response according to the first embodiment of the present invention;

FIG. 19 is a diagram for explaining a fourth variation of the response according to the first embodiment of the present invention;

FIG. 20 is a flowchart for explaining the service information providing process, according to the first embodiment of the present invention;

FIG. 21 is a flowchart for explaining a first variation of the service information providing process, according to the first embodiment of the present invention;

FIG. 22 is a flowchart for explaining a second example of the service information providing process, according to the first embodiment of the present invention;

FIG. 23 is a diagram showing the hardware configuration of the client terminal according to the first embodiment of the present invention;

FIG. 24 is a block diagram for explaining a function of the client terminal according to the first embodiment of the present invention;

FIG. 25 is a diagram for explaining a search service selecting screen according to the first embodiment of the present invention;

FIG. 26 is a diagram for explaining a search result screen according to the first embodiment of the present invention;

FIG. 27 is a flowchart for explaining the service information obtaining process according to the first embodiment of the present invention;

FIG. 28 is a block diagram showing a functional configuration of the multi-functional apparatus according to the second embodiment of the present invention;

FIG. 29 is a diagram showing the service information providing part implemented in the multi-functional apparatus according to the second embodiment of the present invention;

FIG. 30 is a diagram showing the variation of the service information providing part implemented in the multi-functional apparatus according to the second embodiment of the present invention;

FIG. 31 is a block diagram showing the hardware configuration of the multi-functional apparatus according to the second embodiment of the present invention;

FIG. 32 is a diagram showing a system configuration according to a third embodiment of the present invention;

FIG. 33 is a diagram showing a first variation of the system configuration according to the third embodiment of the present invention;

FIG. 34 is a diagram showing a second variation of the system configuration according to the third embodiment of the present invention;

FIG. 35 is a diagram showing a hardware configuration of the service information providing server according to the third embodiment of the present invention;

FIG. 36 is a block diagram for explaining functions of the service information providing process according to the third embodiment of the present invention;

FIG. 37 is a diagram for explaining the service information storing part according to the third embodiment of the present invention;

FIG. 38 is a diagram for emplaning a first variation of the service information storing part according to the third embodiment of the present invention;

FIG. 39 is a diagram for explaining a second variation of the service information storing part according to the third embodiment of the present invention;

FIG. 40 is a diagram for explaining the third variation of the service information storing part according to the third embodiment of the present invention;

FIG. 41 is a diagram for explaining the request according to the third embodiment of the present invention;

FIG. 42 is a diagram for explaining the response according to the third embodiment of the present invention;

FIG. 43 is a diagram for explaining a first variation of the request according to the first embodiment of the present invention;

FIG. 44 is a diagram for explaining a first variation of the response according to the first embodiment of the present invention;

FIG. 45 is a diagram for explaining a second variation of the response according to the first embodiment of the present invention;

FIG. 46 is a diagram for explaining a third variation of the response according to the first embodiment of the present invention;

FIG. 47 is a diagram for explaining a second variation of the request according to the first embodiment of the present invention;

FIG. 48 is a diagram for explaining the fourth variation of the response according to the third embodiment of the present invention;

FIG. 49 is a diagram for explaining the fifth variation of the response according to the third embodiment of the present invention;

FIG. 50 is a flowchart for explaining the service information providing process according to the third embodiment of the present invention;

FIG. 51 is a flowchart for explaining the first variation of the service information providing proves according to the third embodiment of the present invention;

FIG. 52 is a flowchart for explaining a second variation of the service information providing process according to the third embodiment of the present invention;

FIG. 53 is a flowchart for explaining the service information registering process according to the third embodiment of the present invention; and

FIG. 54 is a flowchart for explaining the service information updating process according to the third embodiment of the present invention.

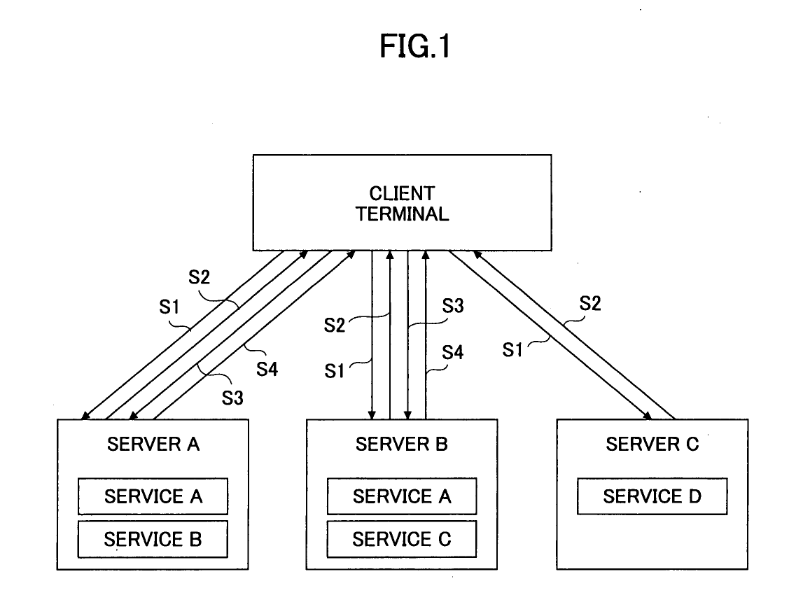

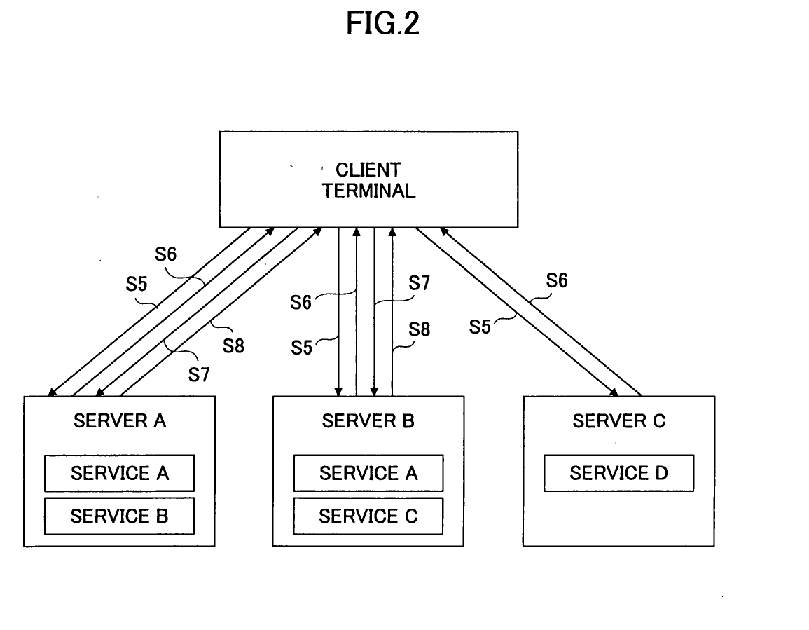

### DESCRIPTION OF THE PREFERRED EMBODIMENT

In the following, embodiments of the present invention will be described with reference to the accompanying drawings.

[System Configuration According to First Embodiment]

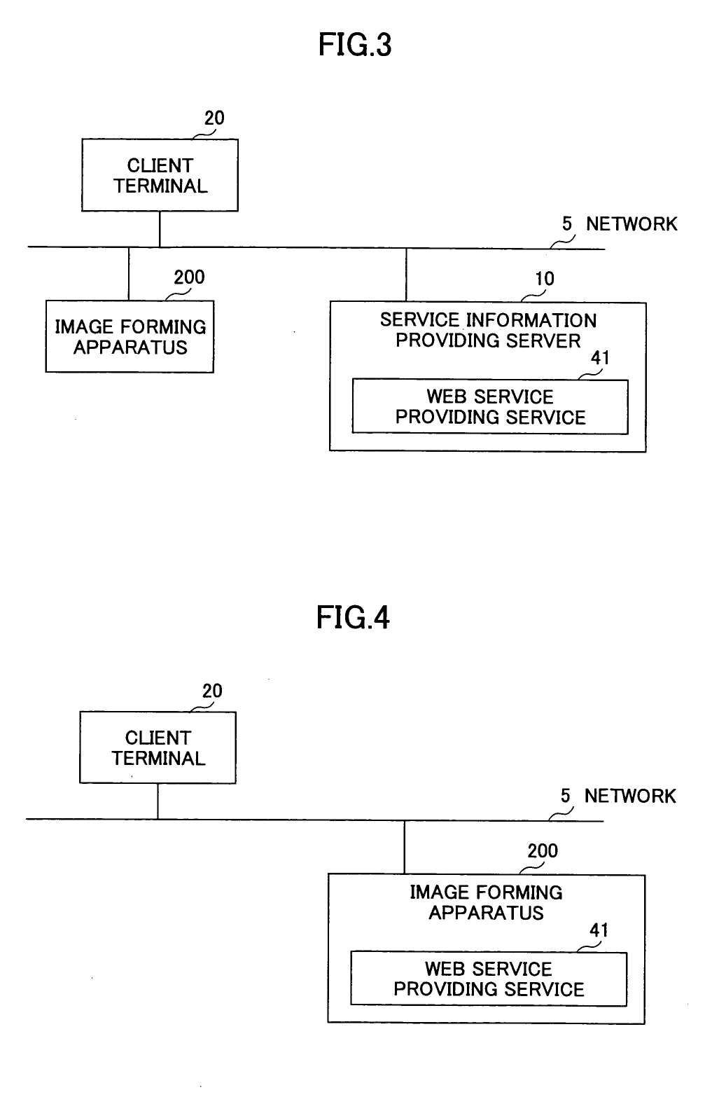

FIG. 3 is a diagram for explaining a system configuration according to a first embodiment of the present invention. In FIG. 3, a configuration necessary for this explanation is shown but other configurations that are not necessary for this explanation are omitted. Similarly, configurations that are not necessary to explain will be omitted in the following drawings.

As shown in FIG. 3, in this system, a service information providing server 10, a client terminal 20, and an image forming apparatus 200 are mutually connected through a network 5.

The client terminal 20 generates a request including a search condition for searching a service, and sends the request to the service information providing server 10.

The service information providing server 10 includes a service providing service 41 for providing the service which the user utilizes. The Web service providing service 41 includes a service information providing part.

The service information providing part provides information concerning the service provided by the web service providing service 41 based on the request.

The client terminal 20 receives and analyzes the response, generates an image showing information concerning the service as display contents, and display the display contents at a display unit.

Moreover, the client terminal 20 generates a request for obtaining a list of information concerning the service which the service information providing server 10 provides, and sends the request to the service information providing server 10.

The service information providing part provides the information concerning the service which the Web service providing service 41, based on the request.

The image forming apparatus 200 is illustrated as an apparatus having a hardware configuration necessary for the Web service providing service 41 to provide the service.

[System Configuration According to Second Embodiment]

FIG. 4 is a diagram for explaining another system configuration according to a second embodiment of the present invention.

In the system configuration shown in FIG. 4, the client terminal 20 and the image forming apparatus 200 are connected to the network 5.

In the system configuration in FIG. 4, different from the system configuration in FIG. 3, the image forming apparatus 200 includes the Web service providing service 41.

As described above, the Web service providing service 41 shown in FIG. 4 includes the service information part which analyses a request from the client terminal 20 and generates a response including information concerning the service which is to be provided by the Web service providing service 41.

[Explanation of First Embodiment]

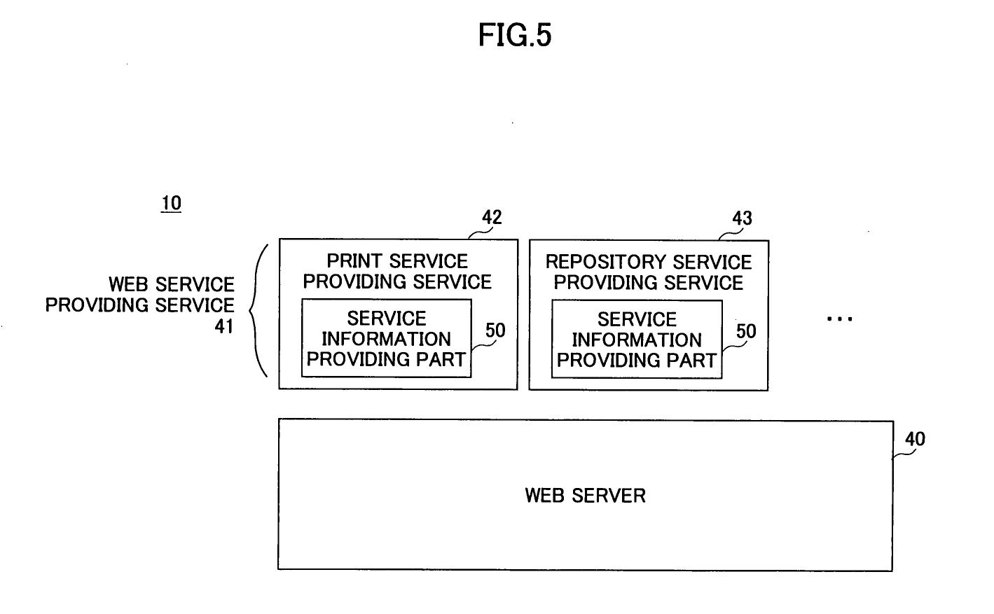

In the following, a functional configuration of the service information providing server 10 is described with reference to FIG. 5.

FIG. 5 is a block diagram showing a functional configuration of the service information providing server according to the first embodiment of the present invention.

As shown in FIG. 5, the service information providing server 10 includes a Web server 40 and the Web service providing service 41. The Web server 40 is software for providing data and functions included in the Web server 40 itself. The service information providing server 10 is a computer for providing data and functions included in the service information providing server 10 itself.

The Web server 40 controls a data communication with the client terminal 20 connected to the network 5 by an HTTP (HyperText Transfer Protocol), calls the Web service providing service 41 indicated in an HTTP request header, sends a process result of the Web service providing service 41 to the client terminal 20 by an HTTP response or a like. It should be noted that the Web server 40 shown in FIG. 5 may have the same configuration as a Web server 500 included in a multi-functional apparatus 1200 that will be described later.

For example, as the Web service providing service 41 for providing the service, the service providing server 10 includes a print service providing service 42 for providing a service concerning a print and a repository service providing service 43 for providing a service concerning a repository. Hereinafter, the print service providing service 42 and the repository service providing service 43 are generally referred as the web service providing service 41.

Each Web service providing service 41 includes a service information providing part 50 that will be described later.

As described later, based on a request obtained by the Web server 40, the service information providing part 50 provides information concerning the service which is to be provided by each Web service providing service 41 corresponding to the request. The service information providing part 50 generates a response and sends the response to the Web server 40.

Each Web service providing service 41 implements a program corresponding to the service information providing part 50, so as to realize the service information providing part 50 as described above.

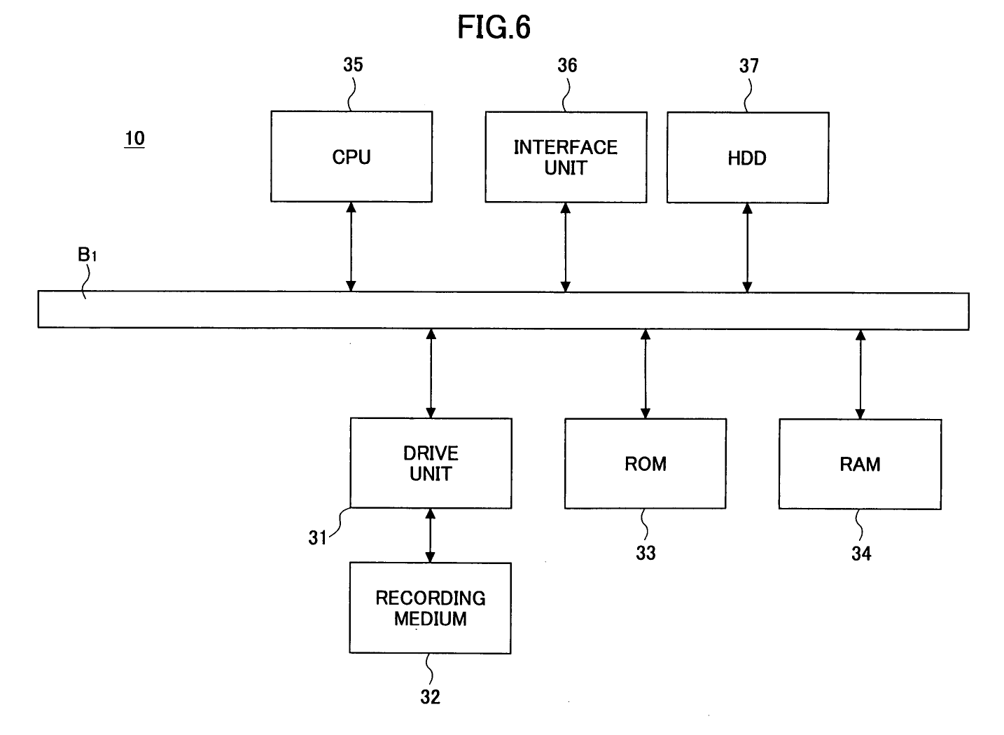

FIG. 6 is a block diagram showing a hardware configuration of the service information providing server according to the first embodiment of the present invention.

In the hardware configuration shown in FIG. 6, the service information providing server 10 includes a drive unit 31, a ROM (Read Only Memory) 33, an RAM (Random Access Memory) 34, a CPU (Central Processing Unit) 35, an Interface unit 36, and an HDD (Hard Disk Drive) 37, which are mutually connected via a bus B1.

The interface unit 36 is an interface to connect the service information providing server 10 to the network 5.

For example, programs corresponding to the print service providing service 42 and the repository service providing service 43 including the service information providing part 50 and a main program for controlling the entire process of the service information providing server 10 may be provided to the service information providing server 10 by using a recoding medium 32 such as a CD-ROM (Compact Disk Read Only Memory). Alternatively, the programs and the main program may be downloaded through the network 5. The recoding medium 32 is set to the drive unit 31, and the programs and the main program are installed into the service information providing server 10 from the recording medium 32.

The ROM 33 stores data. The RAM 34 stores the programs and the main program read from the HDD 37 when the service information providing server 10 is activated. The CPU 35 executes a process in accordance with the programs and the main program stored in the RAM 34.

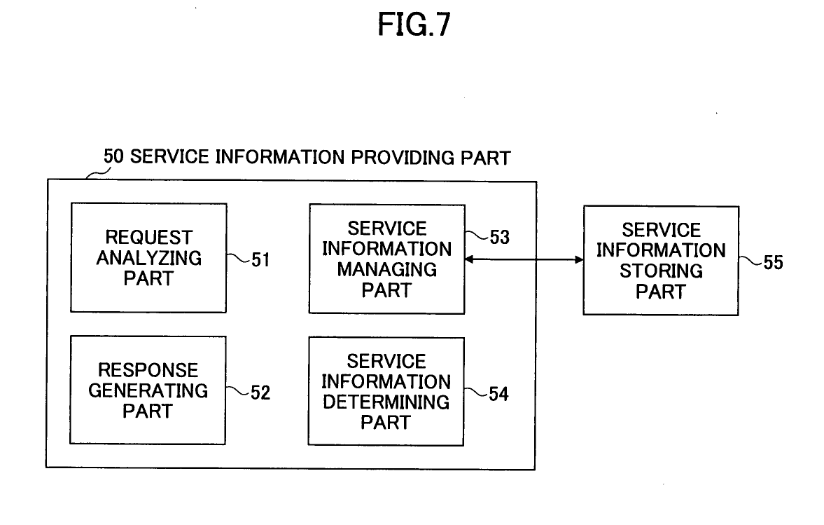

FIG. 7 is a diagram for explaining functions of the service information providing part according to the first embodiment of the present invention.

The service information providing part 50 includes a request analyzing part 51, a response generating part 52, a service information managing part 53, and a service information determining part 54.

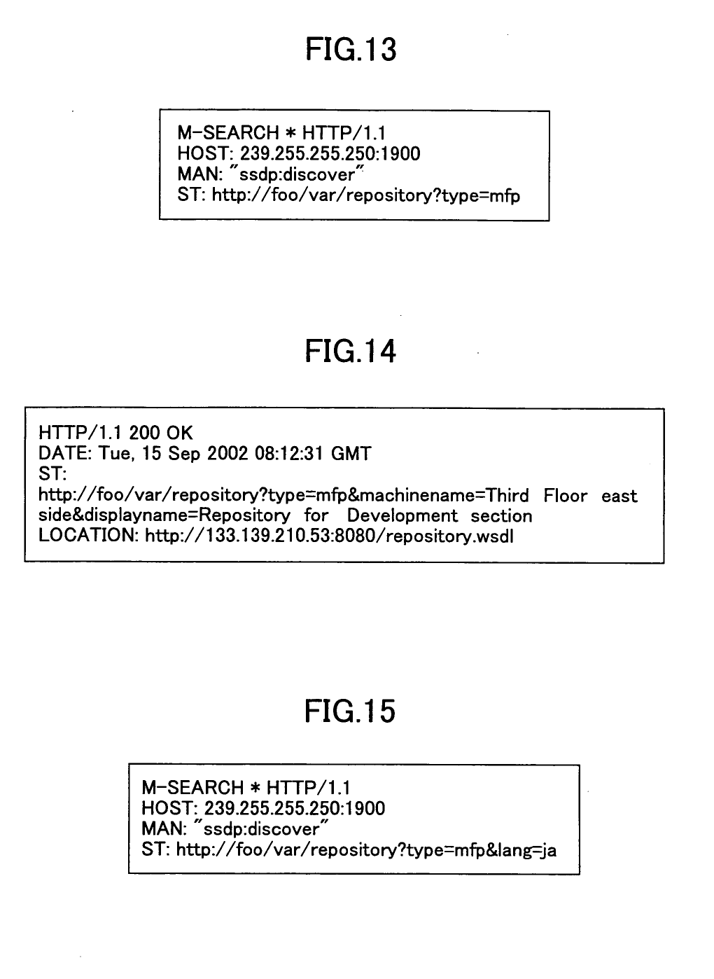

The request analyzing part 51 analyzes contents of a request received from the client terminal 20 and obtained by the Web server 40, and for example, the request analyzing part 51 maintains information included in the request. Details of the request will be described with reference to FIG. 13 and FIG. 15 later.

The service information managing part 53 manages information concerning the service stored in the service information managing part 53. For example, the service information managing part 53 searches the service information storing part 55 based on a search condition included in the request received from the client terminal 20, obtains the information concerning the service matching with the search condition, from the service information storing part 55, and updates the information concerning the service stored in the service information storing part 55.

For example, the service information determining part 54 determines based on the search result of the service information managing part 53 whether or not the service, which the Web service providing service 41 implementing the service information providing part 50 provides, is a service required by the request.

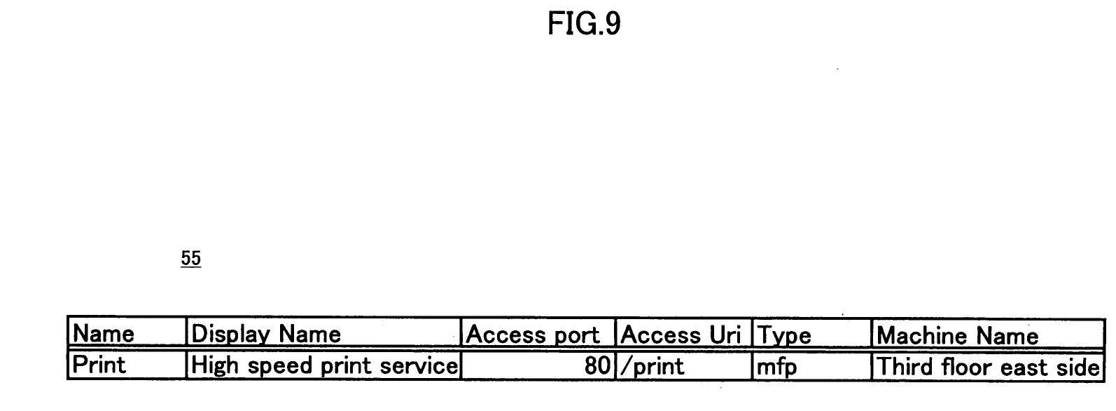

The service information storing part 55 stores the information concerning the service which the Web service providing service 41 implementing the service information providing part 50 provides. Details of information stored in the service information storing part 55 will be described with reference to FIG. 9 through FIG. 12 later.

Instead of including the service information storing part 55 in the service information providing part 50 implemented in each Web service providing service 41, a single service information storing part 55 may be shared with the service information providing parts 50 implemented respectively in a plurality of the Web service providing services 41

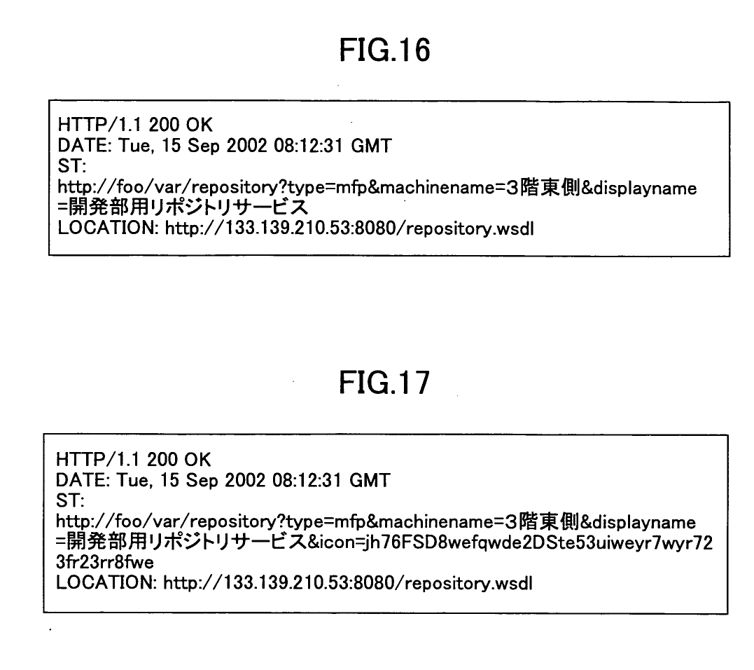

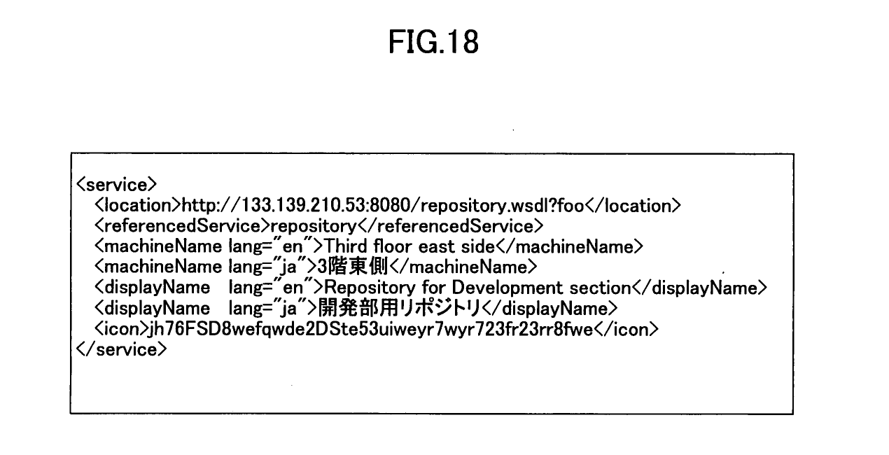

The response generating part 52 generates a response including the information concerning the service which the service information managing part 53 obtains from the service information storing part 55. Details of the response will be described with reference to FIG. 14, FIG. 16, FIG. 17, and FIG. 18.

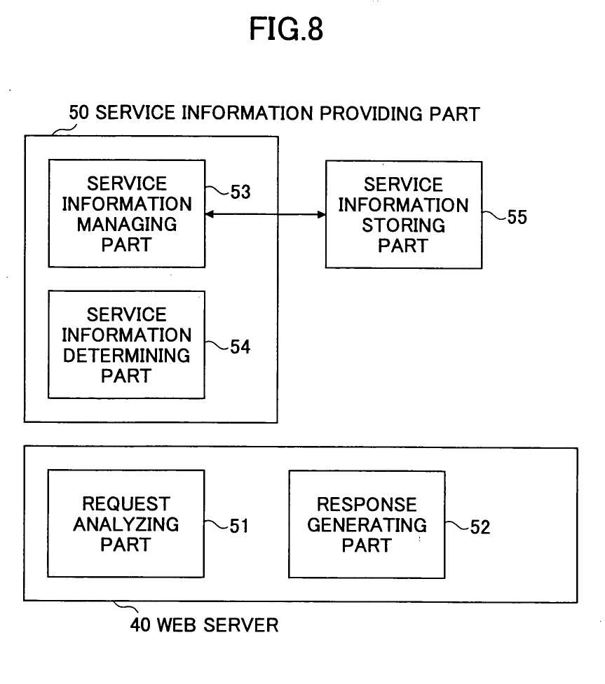

Another functional configuration of the service information providing part 50 will be described with reference to FIG. 8. FIG. 8 is a block diagram for explaining another functional configuration of the service information providing part according to the first embodiment of the present invention.

In the another functional configuration shown in FIG. 8, different from the functional configuration in FIG. 7, the request analyzing part 51 and the response generating part 52 are not included in the service information providing part 50 but are included in the Web server 40.

In the another functional configuration shown in FIG. 8, for example, information included in the request is sent to and managed in the service information managing part 53.

For example, by this functional configuration shown in FIG. 8, even in a case in that the service providing server 10 includes a plurality of the Web service providing services 41 and the service information providing part 50 is implemented for each of the Web service providing services 41, a plurality of the service information providing parts 51 share the request analyzing part 51 and the response generating part 52 with each other.

In the following, for the sake of convenience, as far as the functional configuration of the service information providing part 50 is not referred particularly, the, functional configuration shown in FIG. 7 is applied. However, an implementation of the preset invention is not limited to this functional configuration.

FIG. 9 is a diagram for explaining the service information storing part according to the first, embodiment of the present invention.

As shown in FIG. 9, the service information storing part 55 includes items of “Name”, “Display Name”, “Access port”, “Access Uri”, “Type”, and “Machine Name”.

The item “Name” stores a name of the service which is provided by the Web service providing service 41 implementing the service information providing part 50.

In the item “Display Name”, a name for a display of the service is stored in English.

In the item “Access port”, a port number of an end point (indicated by a POST of a SOAP (Simple Object Access Protocol) request) of the service is stored.

In the item “Access Uri”, a request URI (Uniform Resource Identifier) of the end point (indicated by a POST of a SOAP (Simple Object Access Protocol) of the service. The request URI is positioned after an host description portion of an HTTP URL is stored.

In the item “Type”, an implementation type of the service is stored. For example, even if the implementation type is identical to a name space of the service, a plurality of the services having a different implementation, purpose, performance, security, and charge are implemented. Thus, the item “Type” is used to distinguish each service.

In the item “Machine Name”, a name of an apparatus providing the service is stored in English.

In a case in which a single service information storing part 55 is shared with a plurality of the service information providing parts 50 respectively implemented in the plurality of the Web service providing services 41, information concerning the service provided by each of the plurality of the Web service providing service 41 is stored in each of the items described above.

The service information providing part 50 generates a response including the name for a display of the service provided by the Web service providing service 41 where the service information providing part 50 is implemented, in response to the request (described later) received from the client terminal 20.

The request from the client terminal 20 in this case will be described with reference to FIG. 13 later. The response to the client terminal 20 in this case will be described with reference to FIG. 14 later.

The client terminal 20 can receives the response including the name for a display of the service, the implementation type of the service, and the name of the apparatus providing the service by only a single search of searching for the service through the network 5. Accordingly, the client terminal 20 can generate a screen for display contents showing the name for a display of the service and the name of the apparatus providing the service, which are needed when a user operating the client terminal 20 selects the service, and then displays and provides the display contents to the user.

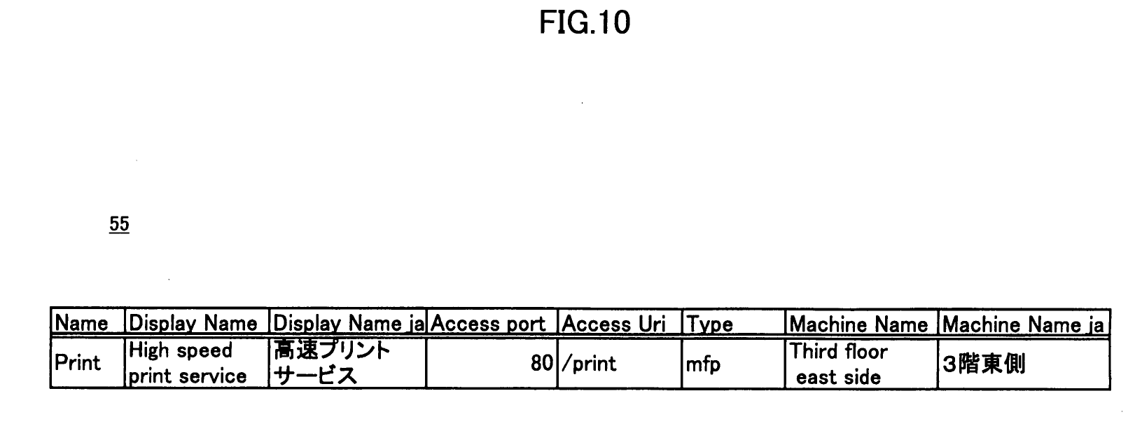

FIG. 10 is a diagram for explaining a first variation of the service information storing part according to the first embodiment of the present invention.

As shown in FIG. 10, the service information storing part 55 includes items of “Name”, “Display Name”, “Display Name ja”, “Access port”, “Access Uri”, “Machine Name”, and “Machine Name ja”.

In the service information storing part 55 shown in FIG. 10, different from the service information storing part 55 shown in FIG. 9, the items “Display Name ja” and “Machine Name ja” are newly added.

In the item “Display Name ja”, the name for a display of the service provided by the Web service providing service 41 where the service information providing part 50 is implemented is stored in Japanese.

In the item “Machine Name ja”, the name of an apparatus providing the service is stored in Japanese.

As described in FIG. 15 later, the service information providing part 50 generates a response including the name for a display of the service and the name of he apparatus providing the service described in Japanese when the request received from the client terminal 20 indicates Japanese as a language describing information concerning the service included in the response.

The request indicating the language will be described with reference to FIG. 15 later. The response including Japanese will be described with reference to FIG. 16.

The client terminal 20 can obtain the response including the name for a display of the service and the name of the apparatus providing the service described in Japanese by only a single search of searching for the service. Accordingly, the client terminal 20 can generate a screen including display contents showing the name for a display of the service and the name of the apparatus providing the service described in Japanese, and provide the display contents to the user.

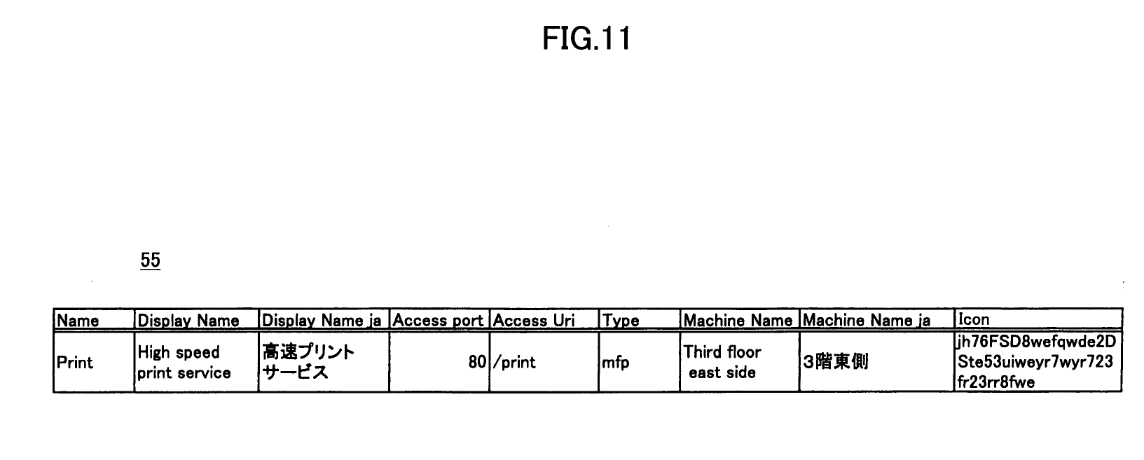

FIG. 11 is a diagram for explaining a second variation of the service information storing part according to the first embodiment of the present invention.

As shown in FIG. 11, the service information storing part 55 includes the items of “Name”, “Display Name”, “Display Name ja”, “Access port”, “Access Uri”, “Type, “Machine Name”, “Machine name ja”, and “Icon”.

In the service information storing part 55 shown in FIG. 11, different from the service information storing part 55 shown in FIG. 10, the item “Icon” is newly added.

In the item “Icon”, information of an icon concerning the service provided by the Web service providing service 41 implementing the service information providing part 50 is stored.

The client terminal 20 generates a screen including the icon concerning the service by obtaining the response including the information of the icon concerning the service.

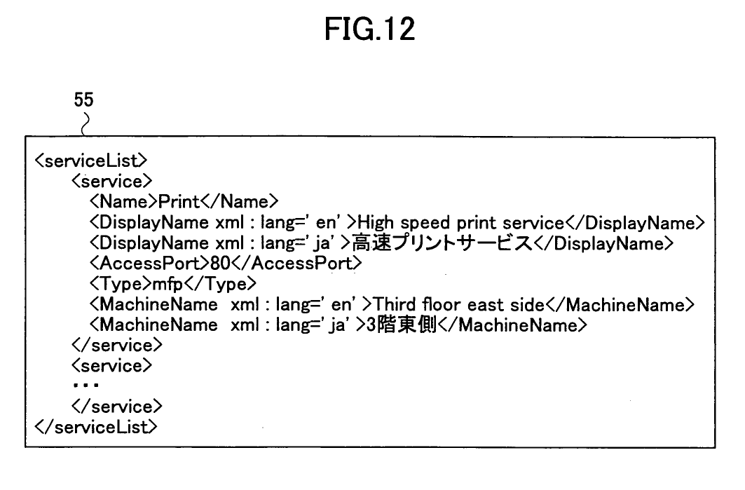

A further variation of the service information storing part 55 will be described with reference to FIG. 12. FIG. 12 is a diagram for explaining a third variation of the service information storing part according to the first embodiment of the present invention.

In FIG. 9 through FIG. 11, the service information storing part 55 is illustrated as a relational database (RDB). Alternatively, as shown in FIG. 12, the service information storing part 55 can be configured as an XML (extensible Markup Language) database (XMLDB). Contents stored in the third variation of the service information storing part are the same as those stored in the first variation of the service information storing part 55.

FIG. 13 is a diagram for explaining the request according to the first embodiment of the present invention.

In the request shown in FIG. 13, an ID of the service to be searched is described as “http://foo/var/repository” after “ST:” and a search condition is described as “type=mfp” after “?” in a “key=value” format.

The client terminal 20 sends a request including the search condition following to “?” by using a multi-cast.

The client terminal 20 can search for the service in accordance with a request of a user by searching for the service using the request including the search condition more appropriately.

The client terminal 20 can indicate a plurality of the search conditions in accordance with a “key1=value1&key2=value2.” format.

FIG. 14 is a diagram for explaining the response according to the first embodiment of the present invention.

In the response shown in FIG. 14, the ID of the service is described as “http://foo/var/repository” after “ST:” and the information concerning the service provided by the Web service providing service 41 implementing the service information providing part 50 is described as “type=mfp&machinename=Third floor east side&displayname=Repository for Development section” after “?”.

In detail, the implementation type of the service is described as “type=mfp”, the name of the apparatus providing the service is described in English as machinename=Third floor east side”, and the name for a display of the service is described in English by “displayname=Repository for Development section”.

In practice, since the response can no include a space, an escape sequence (%20) for an HTTP space character is used, instead of the space. However, for the sake of convenience, the space is included in the response in this embodiment.

Once the service information providing part 50 receives the request as shown in FIG. 13, the service information providing part 50 can generate the response including information needed when the user selects the service such as the implementation type of the service, the name of the apparatus providing the service, and the name, the name for a display of the service, and the like after “?” as shown in FIG. 14, and send to the client terminal 20.

FIG. 15 is a diagram for explaining a first variation of the request according to the first embodiment of the present invention.

In the first variation of the request shown in FIG. 15, “lang=ja” following to “type=mfp&” indicates the language of the information concerning the service to be included in the response corresponding to the request.

In detail, in the request in FIG. 15, “lang=ja” indicates that information corresponding to Japanese in the information concerning the service to be included in the response corresponding to the request should be provided in Japanese by the response.

The client terminal 20 can obtain the information concerning the service described in the language easily understood by the user as the response and provide the information to the user by searching for the service by using the request including language indication information indicating the language of the information concerning the service, which is to be included in the response corresponding to the request, in additional information provided after “?” of the search condition in the request.

FIG. 16 is a diagram for explaining a first variation of the response according to the first embodiment of the present invention.

In the first variation of the response shown in FIG. 16, by “type=mfp&machinename=3 [symbol] &displayname= [symbol] [symbol] [symbol] ”, the information concerning the service provided by the Web service providing service 41 implementing the service information providing part 50 is described in Japanese at portions corresponding to Japanese.

In practice, similar to the space, Japanese potions are described in an escape sequence using “%” in the response. However, for the sake of convenience, this embodiment is described by using Japanese characters themselves.

When the service information providing part 50 receives the request as shown in FIG. 15, the service information providing part 50 analyzes a portion “lang=” included in the request in FIG. 15, generates the response including the information concerning the service described in Japanese after “?” as shown in FIG. 16, and sends the response to the client terminal 20.

FIG. 17 is a diagram for explaining a second variation of the response according to the first embodiment of the present invention.

In the second variation of the response shown in FIG. 17, by “icon=jh76FSD8wefqwde2DSte53uiweyr7wyr723fr23rr8fwe”, the information of the icon concerning the service provided by the Web service providing service 41 where the service information providing part 50 is implemented.

The service information providing part 50 can provide the response including icon information for use to easily understand and select the service to the client terminal 20 by generating the response including the information of the icon concerning the service as shown in FIG. 17, in response to a single request.

FIG. 18 is a diagram for explaining a third variation of the response according to the first embodiment of the present invention.

In addition to sending the service information providing server 10 the request for searching for the service provided by the Web service providing service 41 by using the multi-cast as described with reference to FIG. 13 and FIG. 15, the client terminal 20 sends the service information providing server 10 a GET request of the HTTP 1.1 for obtaining a list of the services provided by the Web service providing service 41 of the service information providing server 10.

The service information providing part 50 implemented in each Web service providing service 41 generates the response as shown in FIG. 18 after receiving the GET request.

Between tags <machineName lang=“en”> and </machineName>, the name of the apparatus providing the service provided by the Web service providing service 41 where the service information providing part 50 is implemented is shown in English.

Between tags <machineName lang=“ja”>and </machineName>, the name of the apparatus providing the service is shown in Japanese.

Between tags <displayName lang=“en”>and </displayName>, the name for a display of the service is shown in English.

Between tags <displayName lang=“ja”>and </displayName>, the name for a display of the service is shown in Japanese.

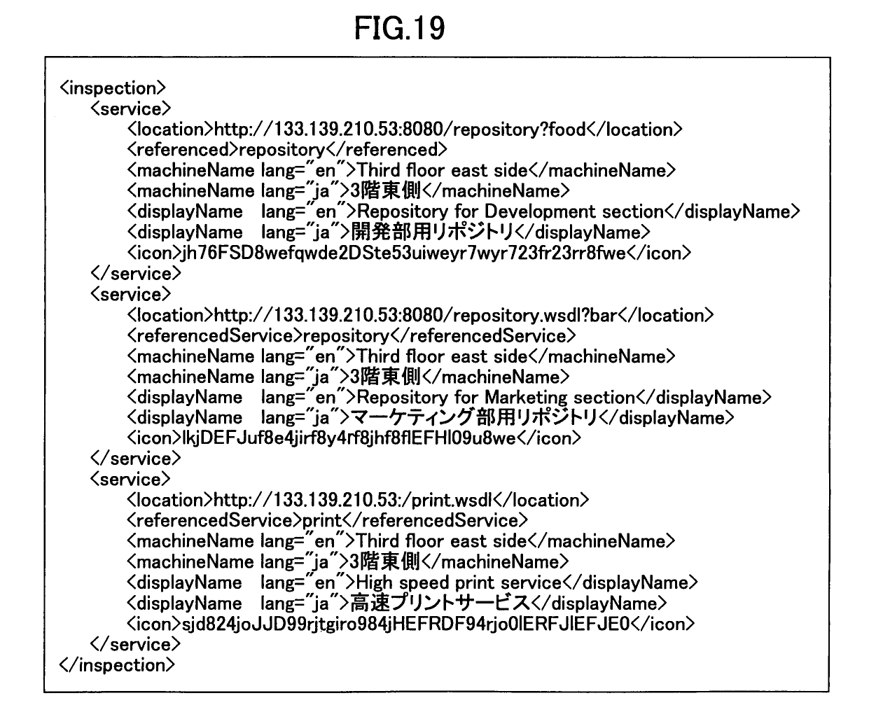

FIG. 19 is a diagram for explaining a fourth variation of the response according to the first embodiment of the present invention.

When the Web server 40 obtains the response as described in FIG. 18 from the service information providing part 50 where each Web service providing service 41 is implemented, the Web server 40 generates a response including a plurality of the response as shown in FIG. 19, and sends the response as shown in FIG. 19 to the client terminal 20.

The service information providing server 10 generates the response including a list of the information concerning the plurality of the services provided by the service information providing server 10 based on a single response from the client terminal 20, and sends the response to the client terminal 20. Therefore, it is possible to provides the client terminal 20 the response including information needed when the user selects the service.

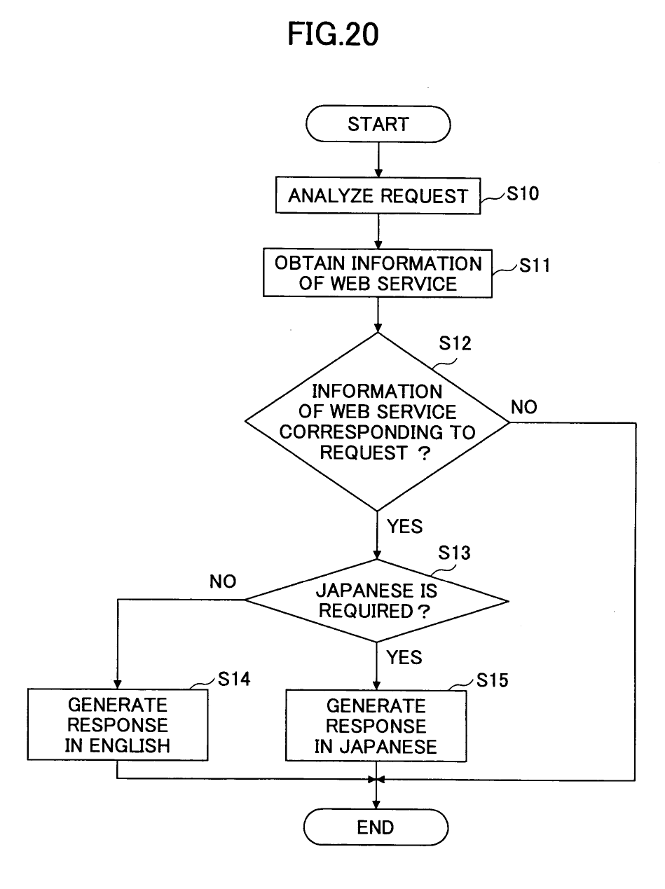

In the following, a service information providing process conducted by the service information providing part 50 will be described with reference to FIG. 20 through FIG. 22.

FIG. 20 is a flowchart for explaining the service information providing process, according to the first embodiment of the present invention.

When the service information providing part 50 obtains the request of a search such as described with reference to FIG. 13 and FIG. 15, which is sent from the client terminal 20 and provided from the Web server 40, the service information providing part 50 starts the service information providing process from the following step 10.

In the step 10, the request analyzing part 51 analyzes contents of the request.

For example, the request analyzing part 51 analyses the search condition (type=mfp) which is described after “?” as described with reference to FIG. 13 and the language indication information indicated by “lang=” described with reference to FIG. 15.

In step S11 following to the step S10, the service information managing part 53 obtains the information concerning the service provided by the Web service providing service 41 where the service information providing part 50 is implemented, from the service information string part 55.

For example, the service information managing part 53 obtains the information concerning the service such as the name for a display of the service, the implementation type of the service, the name of an apparatus providing the service, from the service information storing part 55 as shown in FIG. 9.

In step S12 following to the step S11, the service information determining part 54 compares the search condition analyzed in the step S10 with the information concerning the service obtained in the step S11, and determines whether or not the service provided by the service providing service 41 where the service information providing part 50 is implemented is a service required by the request.

When the service information determining part 54 determines that the service provided by the service providing service 41 where the service information providing part 50 is implemented is the service required by the request (YES of the step S12), the service information providing process advances to step S13. On the other hand, when the service information determining part 54 determines that the service provided by the service providing service 41 where the service information providing part 50 is implemented is not the service required by the request (NO of the step S12), the service information providing process is terminated.

For example, the service information determining part 54 compares a value of “type” of the search condition obtained from the request as shown in FIG. 13 with a value of “implementation type” of the service obtained from the service information storing part shown in FIG. 9, and determines whether or not the service provided by the Web service providing service where the service information providing part 50 is implemented is the service required by the request.

In the step S13, the service information determining part 54 determines based on a result from analyzing in the step S10 whether or not it is required to respond in Japanese.

When the service information determining part 54 determines that it is required to respond in Japanese (YES of the step S13), the service information providing process advances to step S15. On the other hand, when the service information determining part 54 determines that it is not required to respond in Japanese (NO of the step S13), the service information providing process advances to step S14.

For example, the service information determining part 54 checks whether or not “lang=ja” is indicated in the request based on the result from analyzing in the step S10 and determines whether or not it is required to respond in Japanese.

In the step S14, the response generating part 52 generates a response which does not include Japanese, by using the information concerning the service obtained in the step S11 (for example, refer to FIG. 14). Then, the service information providing process is terminated.

In addition, in the step S15, the response generating part 52 generates the response which includes Japanese, by using the information concerning the service obtained in the step S11 (for example, refer to FIG. 16 and FIG. 17). Then, the service information providing process is terminated.

By conducting the service information providing process shown in FIG. 20, for example, the service information providing part 50 can analyze contents of the request of the search as shown in FIG. 15 and generates the response as shown in FIG. 14, FIG. 16, or FIG. 17.

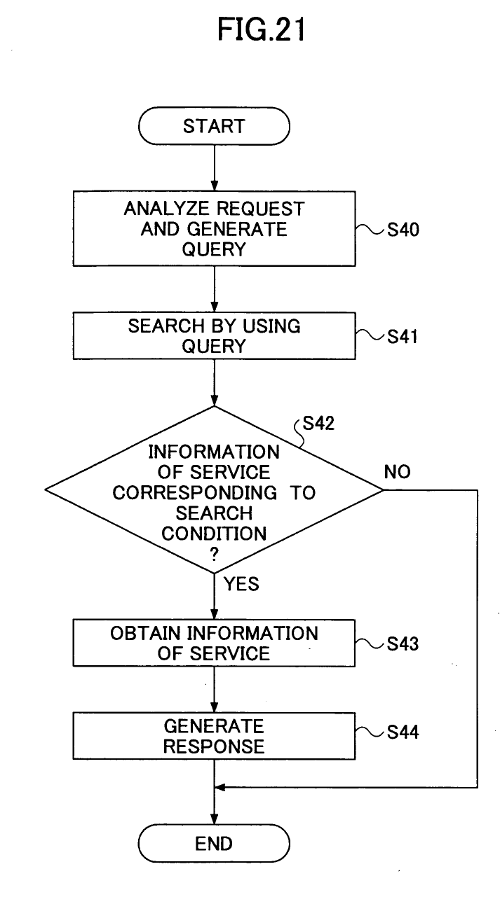

FIG. 21 is a flowchart for explaining a first variation of the service information providing process, according to the first embodiment of the present invention.

When the service information providing part 50 obtains the request of the search as described with reference to FIG. 13 and FIG. 15, which is sent from the client terminal 20 and provided from the Web server 40, the service information providing part 50 starts the information providing process from the following step S40.

In the step S40, the request analyzing part 51 analyzes the contents of the request and generates a query. The request analyzing part 51 generates the query by using an SQL (Structured Query Language) when the service information storing part 55 is an RDB format as shown in FIG. 9 through FIG. 11. The request analyzing part 51 generates the query by using an XQuery when the service information storing part 55 is an XMLDB format as shown in FIG. 12.

In step S41 following to the step S40, the service information managing part 53 executes a search by using the query generated in the step S40, with respect to the service information storing part 55. For example, the query includes the search condition (type=mfp) described after “?” in the request described in FIG. 13 and the language indication information indicated by “lang=” described in FIG. 15.

In step S42 following to the step S41, the service information determining part 54 determines based on a result from the search executed in the step S41 whether or not the information concerning the service is required in the request.

When the service information determining part 54 determines that the information concerning the service required in the request exists (YES of the step S42), the service information providing process advances to step S43. On the other hand, when the service information determining part 54 determines that the information concerning the service required in the request exists (No of the step S42), the service information providing process is terminated.

In the step S43, the service information managing part 53 obtains the information concerning the service required by the request, from the service information storing part 55. For example, in the request, when Japanese is indicated by “lang=”, the service information managing part 53 obtains information concerning the service that is written in Japanese for the information corresponding to Japanese.

In step S44 following to the step S43, the response generating part 52 generates a response including the information concerning the service obtained in the step S43.

By conducting the first example of the service information providing process as shown in FIG. 21, for example, the service information providing part 50 analyses the contents of the request of the search as shown in FIG. 13 or FIG. 15, and generates the response as shown in FIG. 14, FIG. 16, or FIG. 17.

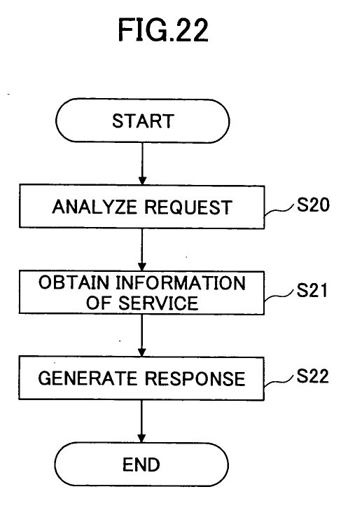

FIG. 22 is a flowchart for explaining a second example of the service information providing process, according to the first embodiment of the present invention.

When the service information providing part 50 obtains a GET request of the HTTP 1.1 sent from the client terminal 20 and provided from the Web server 40, the service information providing part 50 starts the service information providing process from the following step S20.

In the step S20, the request analyzing part 51 analyzes the contents of the request.

Instep S21 following to the step S20, the service information managing part 53 obtains the information concerning the service provided by the Web service providing service 41 where the service information providing part 50 is implemented, from the service information storing part 55.

For example, the service information managing part 53 obtains the information concerning the service such as the name for a display of the service, the implementation type of the service, the name of an apparatus providing the service, and the like.

In step S22 following to the step S21, the response generating part 52 generates an response (for example, refer to FIG. 18).

By conducting the service information providing process shown in FIG. 22, the service information providing part 50 can analyze the contents of the GET request of the. HTTP 1.1, and generate the response as shown in FIG. 18 with respect to the request.

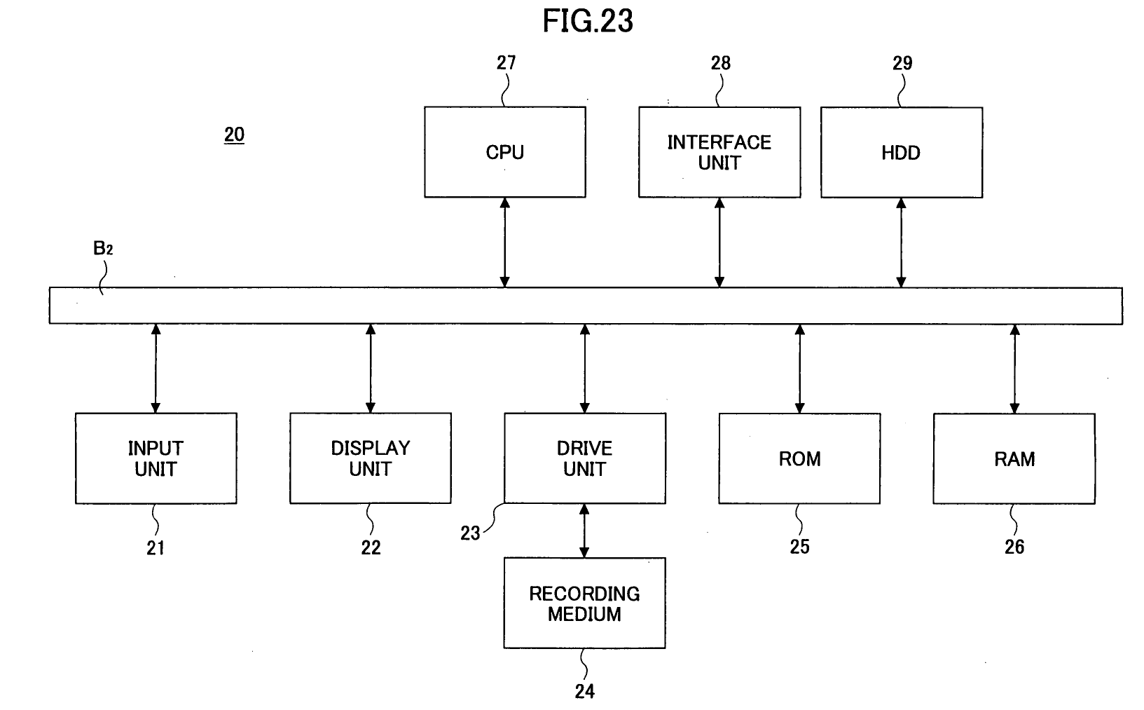

In the following, a hardware configuration of the client terminal 20 will be described with reference to FIG. 23.

FIG. 23 is a diagram showing the hardware configuration of the client terminal according to the first embodiment of the present invention.

In the hardware configuration of the client terminal 20 shown in FIG. 23, the client terminal 20 includes an input unit 21, a display unit 22, a drive unit 23, a ROM (Read Only Memory) 25, an RAM (Random Access Memory) 26, a CPU (Central Processing Unit) 27, an interface unit 28, and a HDD (Hard Disk Drive) 29, which are mutually connected via a bus B2.

The input unit 21 is configured of a keyboard, a mouse, and a like for a user to operate the client terminal 20, and is used to input various operation signals to the client terminal 20.

The display unit 22 is configured of a display for the user to operate the client terminal 20, and displays various screen that will be described later.

The interface unit 28 is an interface to connect the client terminal 20 to the network 50.

For example, a service information obtaining program for obtaining the information concerning the service needed when the user selects the service may be provided by a recording medium 24 such as a CD-ROM to the client terminal 20 or may be downloaded through the network 5. The recording medium 24 is set to the drive unit 23 and data and the service information obtaining program are installed from the recording medium 24 to the HDD 29 through the drive unit 23.

The ROM 25 stores data. The RAM 26 reads the service information obtaining program from the HDD 29 and stores in the service information obtaining program when the client terminal 20 is activated. The CPU 27 executes processes in accordance the service information obtaining program read from the HDD 29 and stored in the RAM 26.

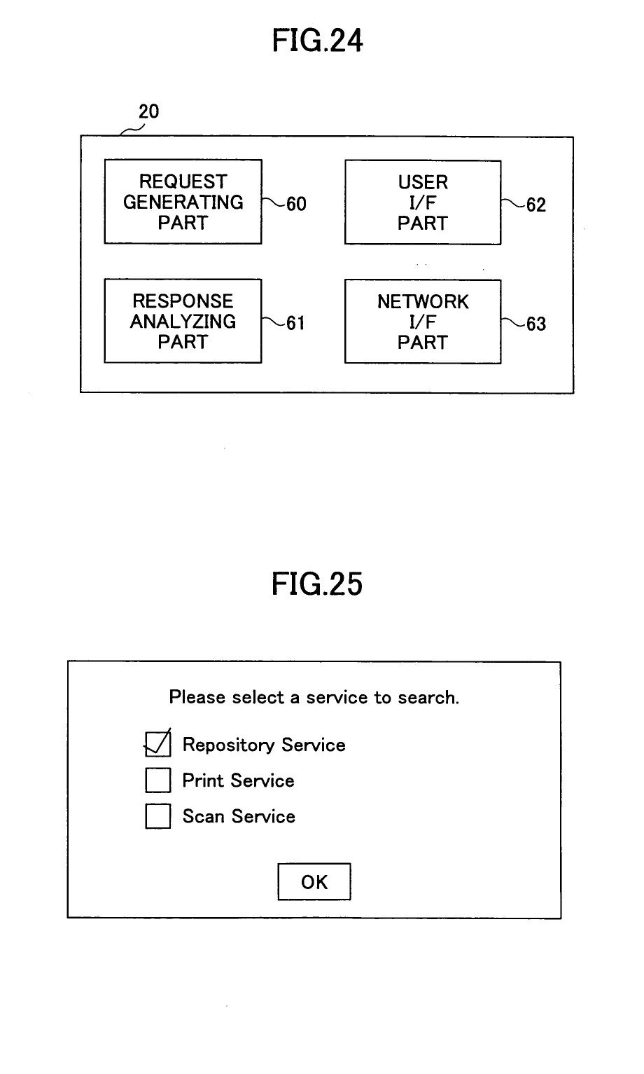

FIG. 24 is a block diagram for explaining a function of the client terminal according to the first embodiment of the present invention.

As shown in FIG. 24, the client terminal 20 includes a request generating part 60, a response analyzing part 61, a user I/F part 62, and a network I/F part 63.

The request generating part 60 generates the request of the search for the service (for example, refer to FIG. 13 and FIG. 15) and the GET request of the HTTP 1.1.

The response analyzing part 61 analyzes the response (for example, refer to FIG. 14, FIG. 16, FIG. 17, and FIG. 19) received from the service information providing server 10.

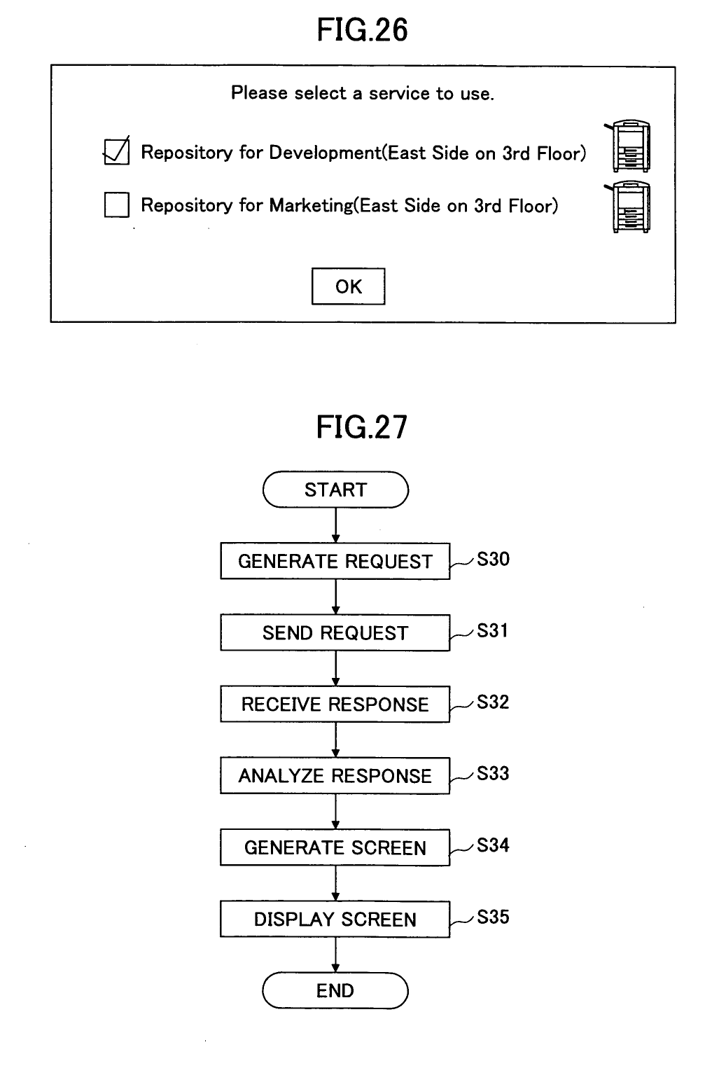

The user I/F part 62 generates screens as shown in FIG. 25 and FIG. 26 that will be described later, and displays the screens. In addition, when the user clicks a button or a like in the screen displayed at the display unit 22, the user I/F part 62 obtains event information and sends the invent information to the request generating part 60.

The network I/F part 63 is an interface to connect the client terminal 20 to other apparatuses, and sends the request generated by the request generating part 60 to the service information providing server 30 through the network 5 and receives the response from the service information providing server 30 through the network 5.

In the following, the screens generated and displayed by the user I/F part 62 will be described with reference to FIG. 25 and FIG. 26.

FIG. 25 is a diagram for explaining a search service selecting screen according to the first embodiment of the present invention.

The user I/F part 62 generates the screen for the user to select the service to search as shown in FIG. 25 based on the request from the user operating the client terminal 20, and displays the screen at the display unit 22.

The user operating the client terminal 20 selects the service to search by using the screen as shown in FIG. 25.

For example, when the user selects “Repository Service” and clicks an OK button, the user I/F part 62 obtains the event information and sends the event information to the request generating part 60.

For example, when the request generating part 60 obtains the event information showing that the user selects “Repository Service” and clicks the OK button, the request generating part 60 generates the request as shown in FIG. 13 and sends the event information to the service information providing server 10.

FIG. 26 is a diagram for explaining a search result screen according to the first embodiment of the present invention.

The client terminal 20 receives the response from the service information providing server 10 (for example, refer to FIG. 14, FIG. 16, FIG. 17, and FIG. 19).

The response analyzing part 61 analyzes the response, and the user I/F part 62 generates a screen as shown in FIG. 26 based on an analysis result by the response analyzing part 61 and displays the screen at the display unit 22.

In FIG. 26, as a result from searching for the service, the name for a display of the service and the name of an apparatus providing the service are described in Japanese and an icon concerning the service (icon for an MFP) is displayed.

As shown in FIG. 25 and FIG. 26, the user can indicate the service to search by using the service information providing server 10 and the client terminal 20 according to the first embodiment of the present invention, and can obtain information needed when the user selects the service, by conducting a single search.

In the following, a service information obtaining process by the client terminal 20 will be described with reference to FIG. 27.

FIG. 27 is a flowchart for explaining the service information obtaining process according to the first embodiment of the present invention.

When the request generating part 60 obtains the information showing that the service to search is indicated and the OK button is clicked by the user at the search service selecting screen as shown in FIG. 25, from the user I/F part 62, the request generating part 60 starts the service information obtaining process from the following step S30.

In the step S30, the request generating part 60 generates the request for searching for the service (for example, refer to FIG. 13 and FIG. 15) and/or the GET request of the HTTP 1.1.

In step S31 following to the step S30, the network I/F part 63 sends the request generated in the step S30 to the network 5.

For example, the network I/F part 63 sends the request for searching for the service shown in FIG. 13 or FIG. 15 to the service information providing server 10 and other apparatuses (or servers) by using the multi-cast through the network 5, and sends the GET request of the HTTP 1.1 to the service information providing server 10.

In step S32 following to the step S31, the network I/F part 63 receives the response to the request for searching for the service from the service information providing server 10 (for example, refer to FIG. 14, FIG. 16, and FIG. 17) and/or receives the response to the GET request of the HTTP 1.1 (for example, refer to FIG. 19).

In step S33 following to the step S32, the response analyzing part 61 analyzes the response obtained in the step S32.

In step S34 following to the step S33, for example, the user I/F part 62 generates an screen as shown in FIG. 26 based on an analysis result in the step S33.

In step S35 following the step S34, the use I/F part 62 displays the screen generated in the step S34 at the display unit 22.

By conducting the service information obtaining process shown in FIG. 27, the client terminal 20 can send the request as shown in FIG. 13 or FIG. 15 and/or the GET request of the HTTP 1.1 to the service information providing server 10, obtain the response as shown in FIG. 14, FIG. 16, or FIG. 17 and/or the response as shown FIG. 19, and provide the user the information needed when the user selects the service by a single request for search for and/or obtaining the information concerning the service.

In the first embodiment, by using a special program, the client terminal 20 analyzes the response as shown in FIG. 14, FIG. 16, or FIG. 17 and the response as shown in FIG. 19, respectively, and generates and displays the screen. Alternatively, for example, either one of the service information providing server 10 and the client terminal 20 may include an XSLT (Extensible Stylesheet Language Transform) processor which transforms a language based on the XML as shown in FIG. 18 and FIG. 19 into another language based on the HTML, and then the response sent from the service information providing server 10 may be displayed at a browser of the client terminal 20.

[Explanation of Second Embodiment]

In the following, as another apparatus in which the service information providing part 50 is implemented and an application providing the service is executed, an image forming apparatus for forming an image (hereinafter, called multi-functional apparatus) will be described.

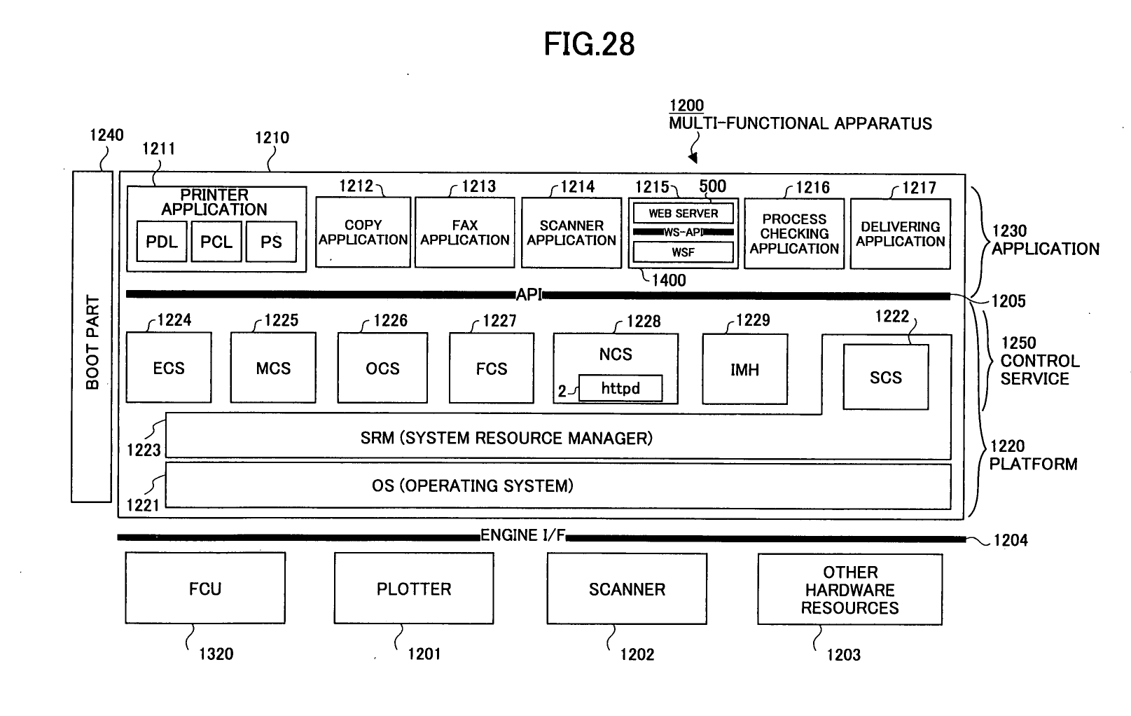

FIG. 28 is a block diagram showing a functional configuration of the multi-functional apparatus according to the second embodiment of the present invention.

In FIG. 28, the multi-functional apparatus 1200 includes a software group 1210 including a platform 1220 and an application 1230, and a boot part 1240, in addition to a plotter 1201, a scanner 1202, and other hardware resource 1203 such as facsimile.

The boot part 1240 is activated first when the multi-functional apparatus 1200 is turned on, and then the platform 1220 and the application 1230 are activated.

The platform 1220 interprets a process request received from the application 1230, and manages the control service 1250 (described later) which generates an acquisition requirement of acquiring hardware resources, and at least one hardware resource. The platform 1220 includes a system resource manager (SRM (System Resource Manager) 1223) that mediates the acquisition requirement from the control service 1250, and an OS (Operating System) 1221.

This control service 1250 is formed of a plurality of services modules; in detail, an SCS (System Control Service) 1222, an ECS (Engine Control Service) 1224, an MCS 1225 (Memory Control Service), an OCS 1226 (Operation panel Control Service), an FCS 1227 (FAX Control Service), an NCS 1228 (Network Control Service), and an IMH (Imaging Memory Handler)1229. In addition, this platform 1220 includes an application program interface that can receive the process request from the above-mentioned application by functions defined beforehand.

The OS 1221 is an operating system such as UNIX™ and executes the platform 1220 and software of the application 1230 in parallel as a process.

The SRM 1223 manages a system control and the hardware resources with the SCS 1222 wia an engine interface 1204, mediates a request from upper layers utilizing hardware resources: an engine part such as the plotter 1201, the scanner 1202 and the like, a memory, an HDD file, host I/Os (a centro I/F, a network I/F, an IEEE1394 I/F, RS232C I/F, and a like), and control an execution with respect to the hardware resources.

The SCS 1222 conducts a plurality of functions: an application management, an operation panel control, a system screen display (a job list screen, a counter display screen, and a like), an LED display, a resource management, an interruption application control, and a like.

The ECS 1224 controls the engine part such as the plotter 1201, the scanner 1202, other hardware resources 1203, and a like, and conducts an image reading operation, a printing operation, a state informing operation, a jam recovering operation, and a like.

MCS 1225 conducts a memory control.

The OCS 1226 is a module for controlling an operation panel as a communicating part between an operator (user) and a controller of the multi-functional apparatus 1200. The OCS 1226 conducts a process for informing the controller an event occurred by a key operation of the operator, a process for providing library functions in order for each application to build a GUI, a process for managing GUI information for each application, and a process for reflecting a display to the operation panel.

The FCS 2227 provides the API (Application Program Interface) 1205 for a facsimile sending/receiving operation to from each application using a PSTN/ISDN, for a registering/referring operation in respect to various facsimile data managed in a BKM (BacKup SRAM), for a facsimile reading operation, for a facsimile receiving and printing operation, and for an integrated sending/receiving operation.

The NCS 1228 is a module group for providing service in order for the application requiring a network I/O to share the network I/O. The NCS 1228 distributes data received in accordance with each protocol from the network to each application, and mediates for the applications when the application send data to the network.

In the second embodiment, for example, NCS 1228 controls data communications with a client terminal, to which the multi-functional apparatus provides a service through the network, in accordance with a HTTP (Hypertext Transfer Protocol) by an HTTP (Hypertext Transfer Protocol) 2. The NCS 1228 executes a plurality of services necessary for a process indicated in specified by the HTTP request header, by a function call. Then, the NCS 1228 sends the client terminal a process result produced by the plurality of services by a HTTP response. For example, the service conducts a process in accordance with a message described in XML (extensible Markup Language).

The IMH 1229 maps image data from a virtual memory area (user virtual space) to a physical memory area.

The application 1230 includes a plurality of applications: a printer applications 1211 for a printer having a Page Description Language (PDL), PCL and Post Script (PS), a copy application 1212 for a copier, an FAX application 1213 for a facsimile, a scanner application 1214 for a scanner, a Web service process application 1215 for processing a service, a process checking application 1216 for checking a process, a delivery application 1217 for delivering information.

The Web service process application 1215 includes a Web server 500 for receiving the HTTP request requesting the service and for sending the HTTP response to provide the service, and a Web service function (WSF) 1400 for conducting a predetermined process by utilizing the control service 1250 via the API 1205 and for providing the service via a WS-API (Web Service Application Program Interface).

Similar to the system configuration shown in FIG. 4, the multi-functional apparatus 1200 is connected to the client terminal 20 via the network 5. The Web service providing service 41 described with reference to FIG. 4 corresponds to the Web service process application 1215.

For example, the service information providing part 50 described in the first embodiment can be realized by implementing a program corresponding to the service information providing part 50 to each Web service function (WSF) 1400.

It should be noted that a process conducted by the service information providing part 50 is similar to that described in the first embodiment.

When the service information providing part 50 receives the request for searching for the service described with reference to FIG. 13 and FIG. 15, from the client terminal 20 connected to the multi-functional apparatus 1200 through the network 5, the service information providing part 50 starts the process shown in FIG. 20, and generates the request as shown in FIG. 14, FIG. 16, or FIG. 17.

In addition, when the service information providing part 50 receives the GET request of the HTTP 1.1 from the client terminal 20, the service information providing part 50 starts the process shown in FIG. 22 and generates the response as shown in FIG. 18 with respect to the GET request.

In the multi-functional apparatus 1200, processes shared with applications 1211 through 1217 are centralized in the platform 1220.

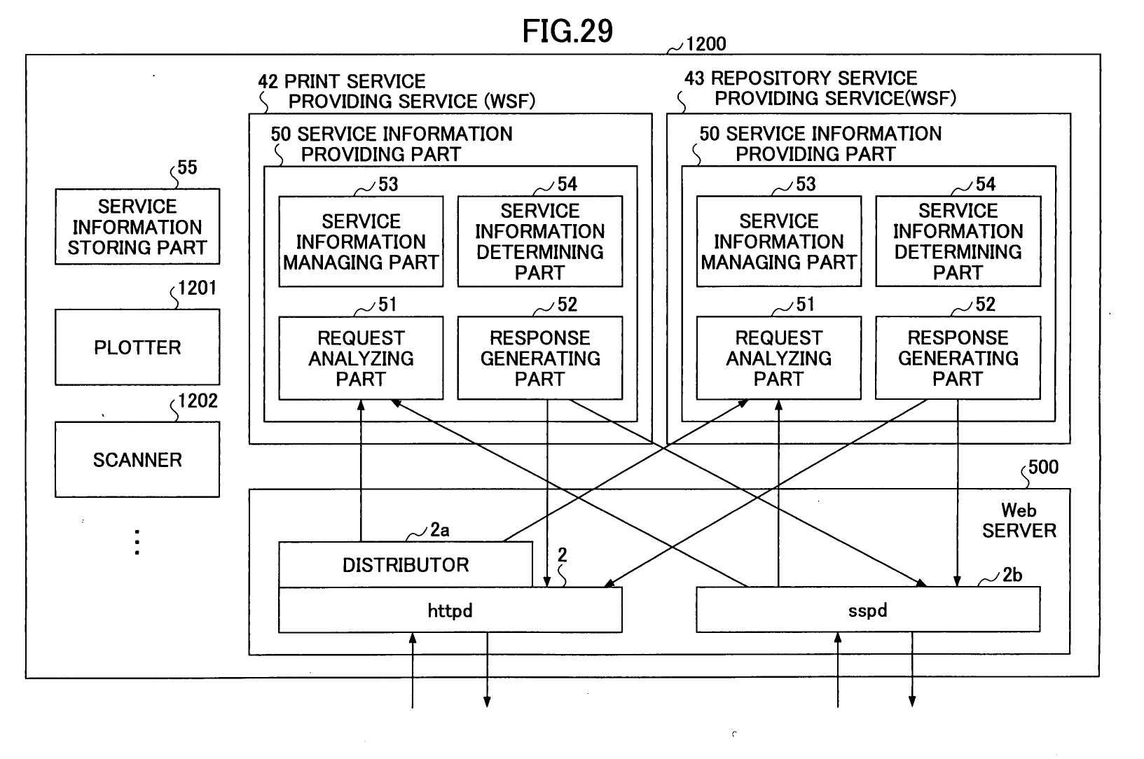

Next, the service information providing part 50 implemented in the multi-functional apparatus 1200 will be described with reference to FIG. 29. FIG. 29 is a diagram showing the service information providing part implemented in the multi-functional apparatus according to the second embodiment of the present invention.

As shown in FIG. 29, the service information providing part 50 is implemented for each of the print service providing service 42 and the repository service providing service 43 which are Web service functions 1400, and includes a request analyzing part 51, a response generating part 52, a service information managing part 53, and a service information determining part 54.

It should be noted that a distributor 2a is a distributing part for distributing a process to one of the Web service functions 1400 corresponding to an HTTP request and an sspd 2b is a daemon for exchange information described in the XML with the client terminal 20 based on an SSDP (Simple Service Discover Protocol).

The service information storing part 45 is configured of an HDD 1303, a flash memory, or a like of the multi-functional apparatus 1200, which will be described later.

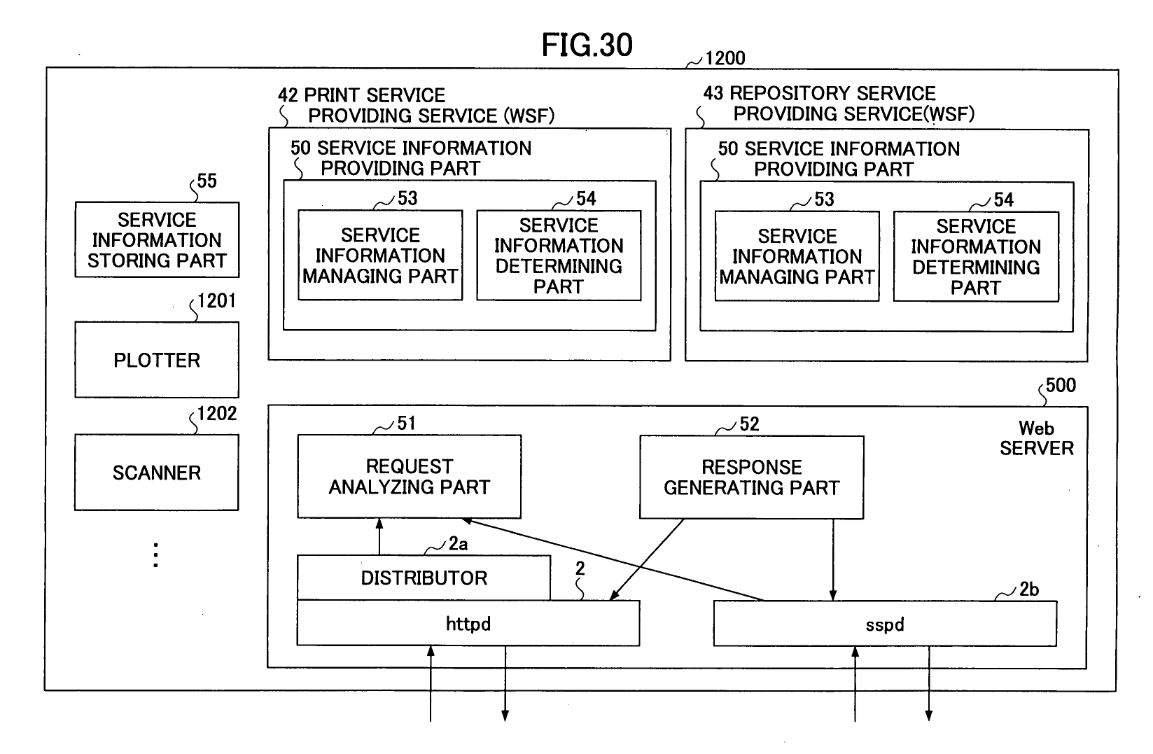

A variation of the service information providing part 50 implemented in the multi-functional apparatus 1200 will be described with reference to FIG. 30. FIG. 30 is a diagram showing the variation of the service information providing part implemented in the multi-functional apparatus according to the second embodiment of the present invention.

In a functional configuration of the service information providing part 50 shown in FIG. 30, different from the functional configuration of the service information providing part 50 shown in FIG. 29, the request analyzing part 51 and the response generating part 52 are not included in the service information providing part 50 but are included in the Web server 500.

by this functional configuration shown in FIG. 30, even if a plurality of the Web service functions 1400 are included in the multi-functional apparatus 1200 and the service information providing part 50 is implemented for each of the plurality of the Web service functions 1400, a plurality of the service information providing parts 50 can share the request analyzing part 51 and the response generating part 52 with each other.

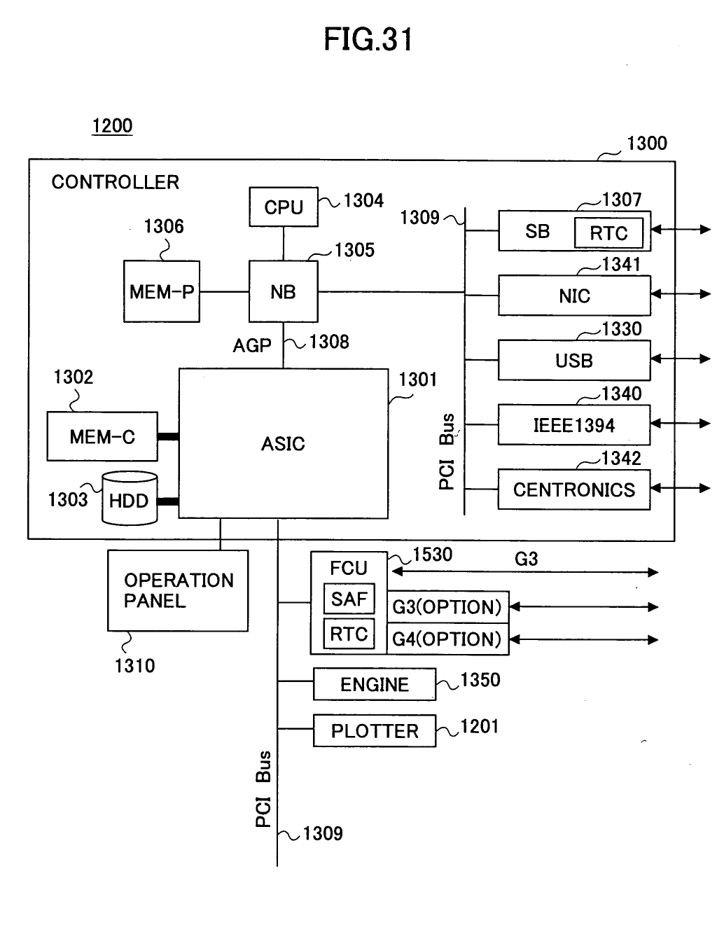

Next, a hardware configuration of the multi-functional apparatus 1200 will be described with reference to FIG. 31. FIG. 31 is a block diagram showing the hardware configuration of the multi-functional apparatus according to the second embodiment of the present invention. As shown in FIG. 31, in the multi-functional apparatus 1200, an operation panel 1310, a FAX control unit. (FCU) 1530, an engine part 1350 (the scanner 1202 and the like are connected to), and the plotter 1201, and an ASIC 1301 of a controller 1300 are connected via a PCI (Peripheral Component Interconnect) bus 1309 and a like.

In the controller 1300, the ASIC 1301 is connected to an MEM-C 1302 and the HDD (Hard Disk Drive) 1303 and the ASIC 1301 is also connected to a CPU 1304 via an NB 1305 of a CPU chipset.

The CPU 1304 controls the entire multi-functional apparatus 1200. In detail, the CPU 1304 activates and executes the SCS 1222, the SRM 1223, the ECS 1224, the MCS 1225, the OCS 1226, the FCS 1227, and the NCS 1228, which form the platform 1220 on the OS 1221, as processes, respectively. In addition, the CPU 1304 activates and executes the printer application 1211, the copy application 1212, the fax application 1213, the scanner application 1214, the Web service process application 1215, the process checking application 1216, and the delivering application 1217, which form the application 1213.

The NB 1305 is a bridge for connecting the CPU 1304 to an MEM-P 1306, an SB 1307, an NIC (Network Interface Card) 1341, a USB (Universal Serial Bus) 1330, an IEEE 1394 1340, a centronics 1342, and the ASIC 1301.

The MEM-P 1306 is a system memory used as a memory for a image in the multi-functional apparatus 1200, and is a bridge for connecting the SB 1307, the NB 1305 and the ROM, PCI devices, and peripheral devices. The MEM-C 1302 is a local memory used as an image buffer for a copy and a code buffer. The ASIC 1301 is an IC, which includes hardware elements for the image process, for an image process.

The HDD 1303 is a storage for storing image data, programs, font data, forms. The operation panel 1310 is an operating part for receiving an input operation from the operator and displaying information for the operator.

Accordingly, an RAM interface for connecting to the MEM-C 1302 and a hard disk interface for connecting to the HDD 1303 are provided to the ASIC 1301. When image data is input to or output from the MEM-C 1302 and the HDD 1303, the RAM interface or the hard disk interface is switched for an input or an output.

The AGP 1308 is a bus interface for a graphic accelerator card that is offered to improve a speed in a graphic process and can realize the graphic accelerator card to be higher speed by directly accessing the system memory at higher throughput.

Even if an apparatus, which implements the service information providing part 50 and executes an application providing the service, is the multi-functional apparatus 1200, the client terminal 20 can generate and send the request for searching for the service (for example, refer to FIG. 13 or FIG. 15) and/or the GET request of the HTTP 1.1 to the multi-functional apparatus 1200. And the client terminal 20 receives the response for searching for the service (for example, refer to FIG. 14, FIG. 16, or FIG. 17) and/or the response (for example, refer to FIG. 19) with respect to the GET request of the HTTP 1.1. Therefore, it is possible to provide information needed when the user selects the service, by a single request for searching for the service.

According to the present invention, it is possible to promptly provide information needed when the user selects the service desired by the user.

Moreover, according to the present invention, it is possible to promptly obtain information needed when the user selects the service desired by the user.

According to the first embodiment and the second embodiment, a service providing apparatus according to present invention can be realized by installing or downloading a computer-executable program for causing a computer to execute a process in a service providing part for providing a service which a user utilizes, the program including the code for providing information concerning the service utilized when the user selects the service, in response to a request from a user terminal.

Moreover, a service utilizing terminal according to the present invention can be realized by installing or downloading a computer-executable program for causing a computer to utilize a service provided by a service providing part, the program including the codes for: (a) creating a request including a search condition concerning the service; and (b) receiving a response including information concerning the service utilized when the user selects the service, the response corresponding to the request.

[Third Embodiment]

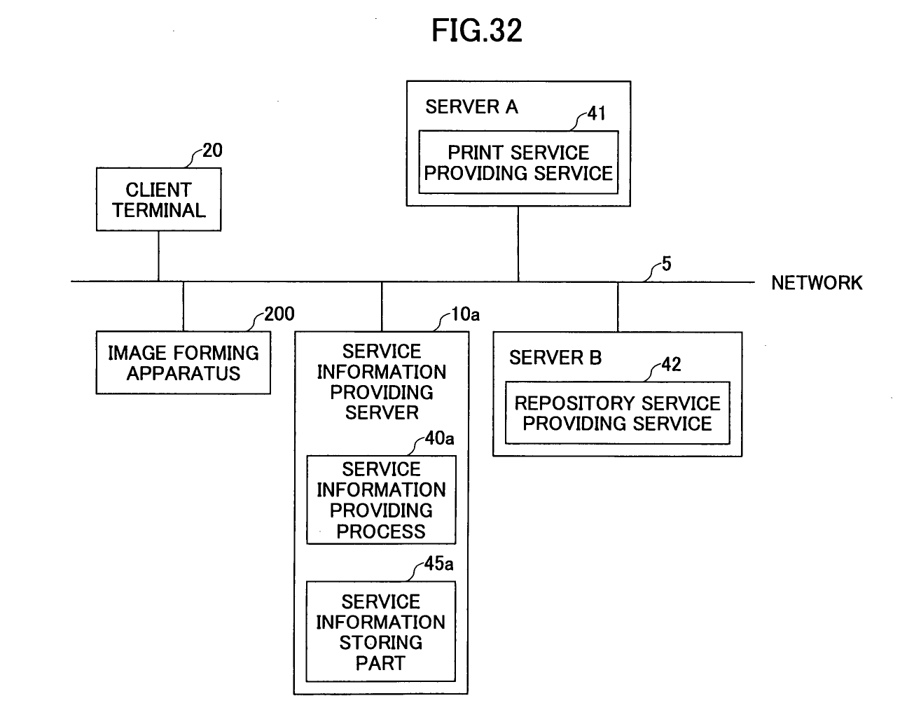

FIG. 32 is a diagram showing a system configuration according to a third embodiment of the present invention. In FIG. 32, a configuration necessary for this explanation is shown but other configurations that are not necessary for this explanation are omitted. Similarly, configurations that are not necessary to explain will be omitted in the following drawings.

In the system configuration shown in FIG. 32, a client terminal 20, a service information providing server 10a, an image forming apparatus 200, a server A, and a server B are mutually connected via a network 5.

The service information providing server 10a includes a service information providing process 40a, and a service information storing part 45a. For example, the service information storing part 45a stores information concerning a print service provided by a print service providing service 41, which is provided in the server A managed by the service information providing server 10a, and information concerning a repository server provided a repository service providing service 42, which is provided in the server B managed by the service information providing server 10a.

The client terminal 20 generates a request including a search condition for searching for a service, and sends the request which is generated, to the service information providing server 10a.

When the service information providing process 40a of the service information providing server 10a receives the request sent from the client terminal 20, the service information providing process 40a analyzes the request, generates a response with respect to the request by using information concerning the service stored in the service information storing part 45a, and sends the response to the client terminal 20.

The client terminal 20 receives and analyzes the response. Then, the client terminal 20 generates a screen showing the information concerning the service and displays the screen at a display.

In addition, the client terminal 20 generates a request for obtaining a list of information concerning services which are provided by the service information providing server 10a and servers managed by the service information providing server 10a, and sends the request to the service information providing server 10a.

when the service information providing process 40a of the service information providing server 10a receives the request sent from the client terminal 20, the service information providing process 40a analyzes the request, generates a response with respect to the request by using information concerning the services stored in the service information storing part 45a, and sends the response to the client terminal 20.

The image forming apparatus 200 includes a hardware function as a printer to provide the print service by the print service providing service 41. Similarly, the image forming apparatus 200 includes a hardware function to store document data and a like to provide the repository service by the repository service providing service 42.

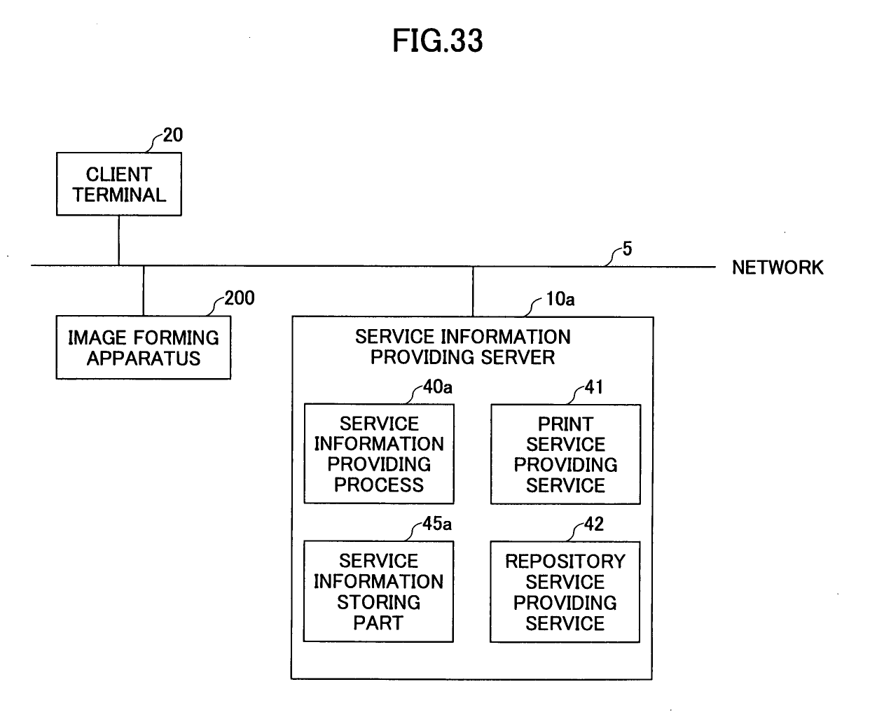

FIG. 33 is a diagram showing a first variation of the system configuration according to the third embodiment of the present invention.

In the system configuration shown in FIG. 33, the client terminal 20 and the service information providing server 10a are connected through the network 5.

Different from the system configuration in FIG. 23, in the first variation of the system configuration in FIG. 33, the print service providing service 41 for providing the print service and the repository service providing service 42 for providing the repository service are included in the service information providing server 10a.

The service information providing server 10a may includes applications for providing various services in addition to the service information providing process 40a and the service information storing part 45a.

Even in the system configuration as shown in FIG. 33, as described above, when the service information providing process 40a receives the request sent from the client terminal 20, the service information providing process 40a analyzes the request, generates the response with respect to the request by using the information concerning the service stored in the service information storing part 45a, and sends the response to the client terminal 20.

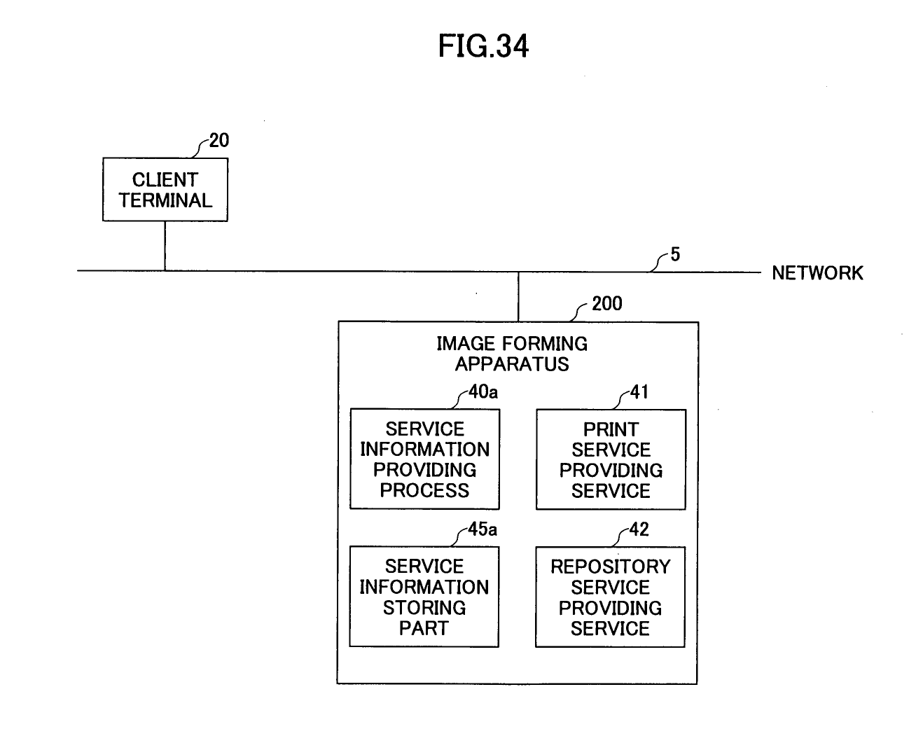

FIG. 34 is a diagram showing a second variation of the system configuration according to the third embodiment of the present invention.

In the system configuration shown in FIG. 34, the client terminal 20 and the image forming apparatus 200 are connected through the network 5.

Different from the system configurations in FIG. 32 and FIG. 33, in the second variation of the system configuration shown in FIG. 34, the service information providing process 40a, the service information storing part 45a, the print service providing service 41, and the repository service providing service 42 are included in the image forming apparatus 200.

Even in the second variation of the system configuration as shown in FIG. 34, as described above, when the service information providing process 40a receives the request sent from the client terminal 20, the service information providing process 40a analyzes the request, generates the response with respect to the request by using the information concerning the service stored in the service information storing part 45a, and sends the response to the client terminal 20.

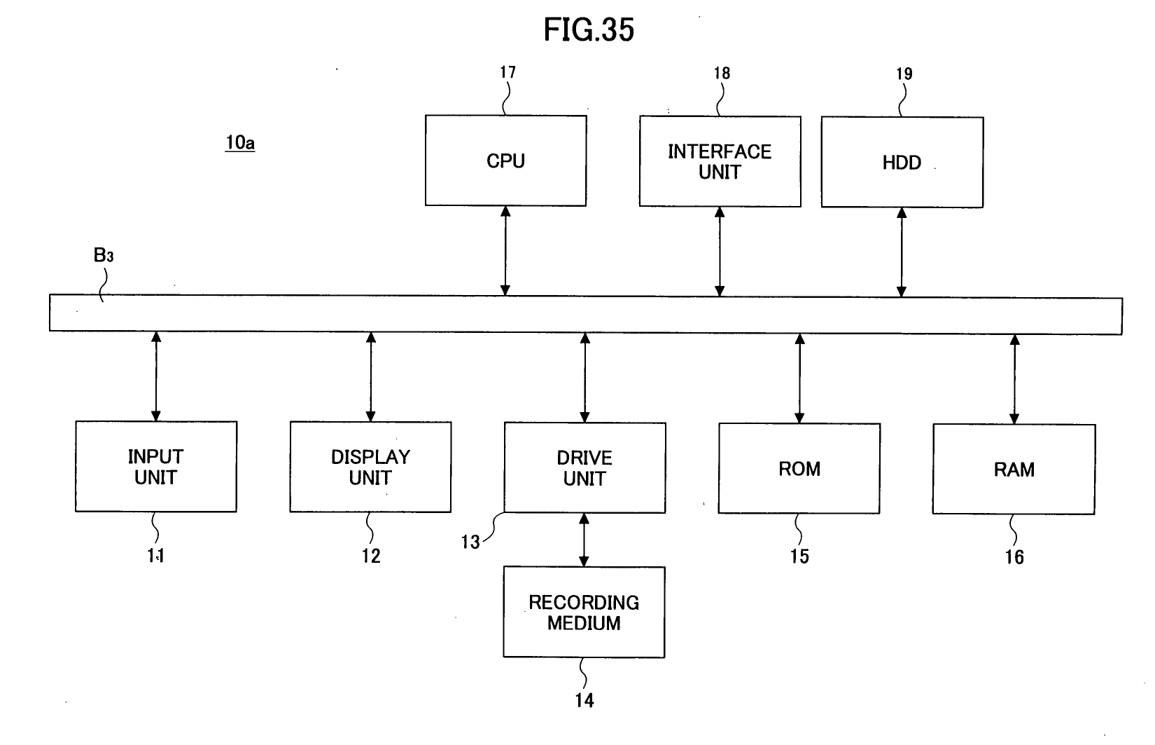

FIG. 35 is a diagram showing a hardware configuration of the service information providing server according to the third embodiment of the present invention.

In the hardware configuration of the service information providing server 10a shown in FIG. 35, the service information providing server 10a includes an input unit 11, a display unit 23, a drive unit 13, a ROM (Read Only Memory) 15, an RAM (Random Access Memory) 16, a CPU (Central Processing Unit) 17, an interface unit 18, and an HDD (Hard Disk Drive) 19, which are mutually connected via a bus B3.

The input unit 11 includes a keyboard, a mouse, and a like for a user of the service information providing server 10a to operate, and is used to input various operation signals to the service information providing server 10a.

The display unit 12 includes a display for the user of the service information providing server 10a to operate, and displays various screens that will be described later.

The interface unit 18 is an interface connecting the service information providing server 10a to the network 5.

For example, a service information providing program corresponding to the service information providing process 40a and a main program for controlling the entire service information providing server 10a can be provided by a recording medium 14 such as a CD-ROM or downloaded through the network 5. The recording medium 14 is set in the drive unit 13 and the service information providing program, the main program, and the like are installed from the recording medium 14 to the HDD 19 through the drive unit 13.

The ROM 15 stores data. The RAM 16 stores the programs and the main program read from the HDD 19 when the service information providing server 10a is activated. The CPU 17 executes a process in accordance with the programs and the main program stored in the RAM 16.

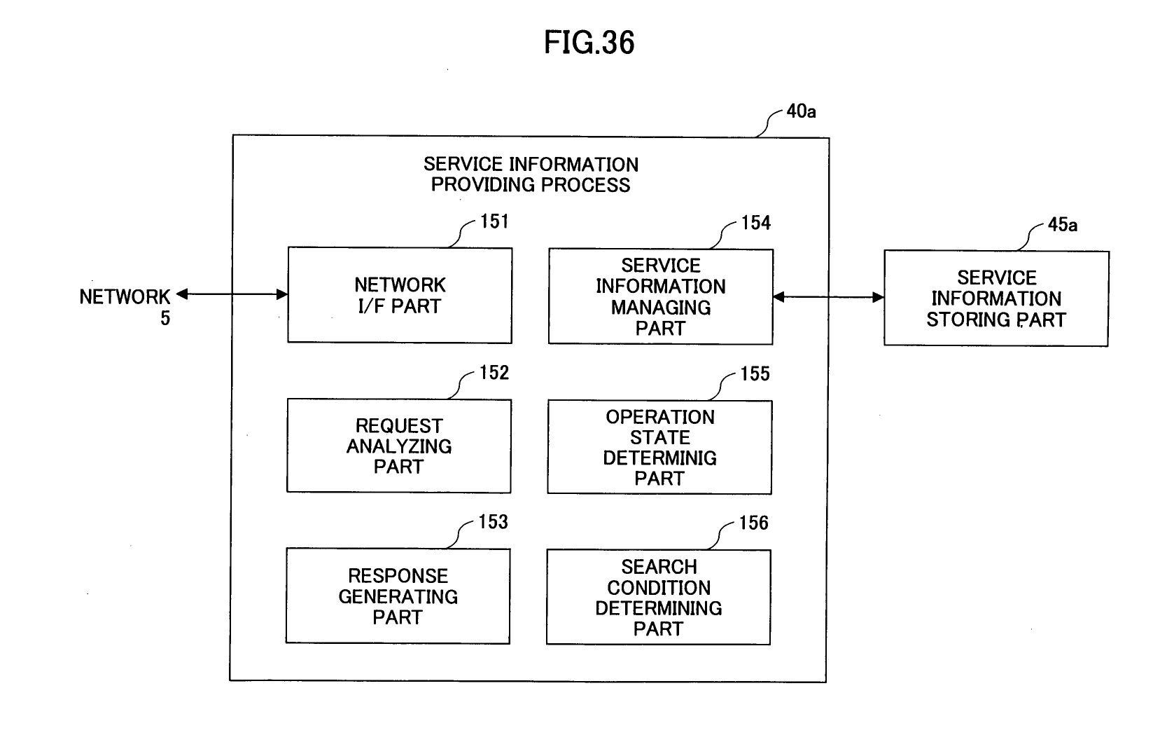

FIG. 36 is a block diagram for explaining functions of the service information providing process according to the third embodiment of the present invention.

The service information providing process 40a includes a network I/F part 151, a request analyzing part 152, a response generating part 153, a service information managing part 154, a operation state determining part 155, and a search condition determining part 156.

The network I/F part 151 receives the request sent from the client terminal 20 through the network 5, sends the request to the request analyzing part 152, and send the response generated by the response generating part 153 to the client terminal 20 through the network 5.

The request analyzing part 152 analyzes contents of the request received from the network I/F part 151 and maintains information included in the request.

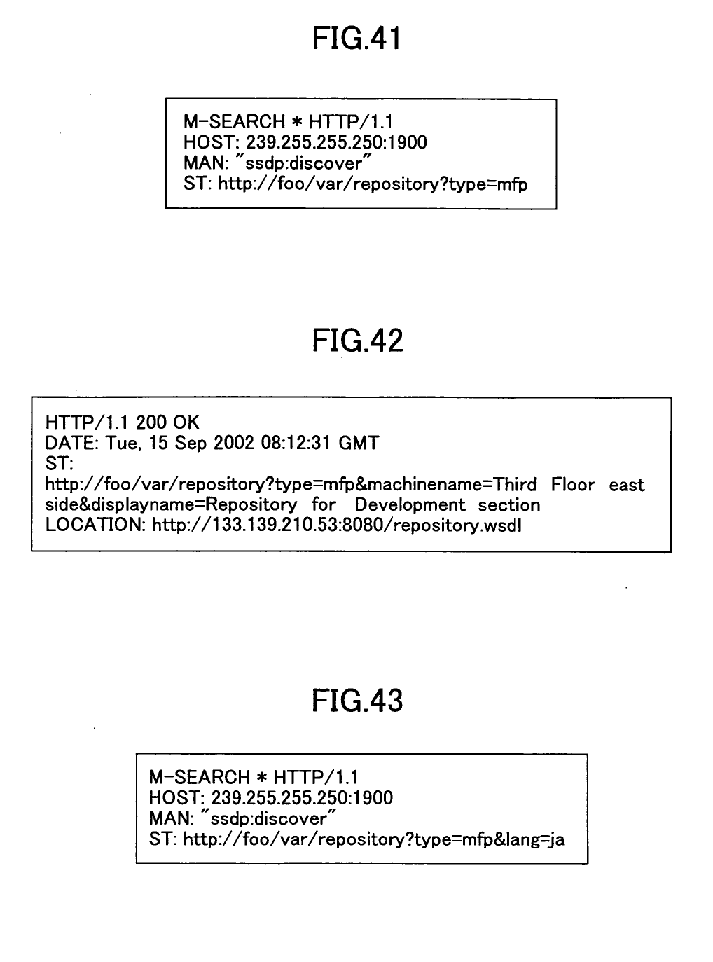

Details of the request will be described with reference to FIG. 41, FIG. 43, and FIG. 47 later.

The service information managing part 154 manages information concerning the service providing service providing a service and information concerning the service stored in the service information managing part 53. For example, the service information managing part 53 searches the service information storing part 55 based on a search condition included in the request received from the client terminal 20, obtains the information concerning the Web service matching with the search condition, from the service information storing part 55. For example, in FIG. 32, the service information providing server 10a obtains information concerning each of the service providing services 41 and 42 implemented in the servers A and B, respectively, and information concerning the service form each of the servers A and B and registers the information to the service information storing part 45a. Also, in FIG. 33, the service information providing server 10a obtains information concerning each of the service providing services 41 and 42 implemented in the service information providing server 10a itself and information concerning the service from each of the service providing services 41 and 42 and registers the information to the service information storing part 45a.

For example, the information concerning each of the service providing services 41 and 42 is information showing that the service providing service 41 or 42 is in an operation state or a stop state. For example, the information concerning the service provided each of the service providing services 41 and 42 shows a name of the service, a name for a display of the service, and an implementation type of the service.

For example, the service information managing part 154 searches for the service information storing part 45a based the search condition included in the request from the client terminal 20, obtains the information concerning the service corresponding to the search condition from the service information storing part 45a, obtains the information concerning the service stored in the service information storing part 45a, and updates the information concerning the service stored in the service information storing part 45a

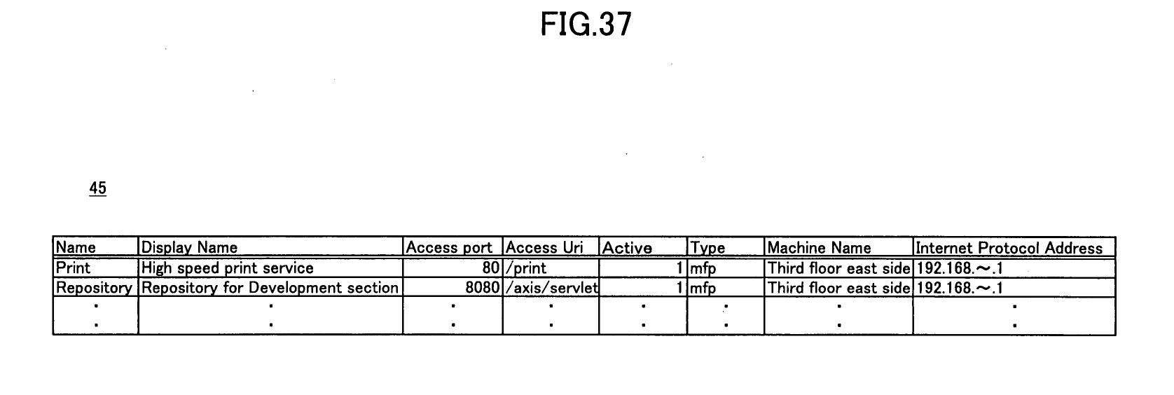

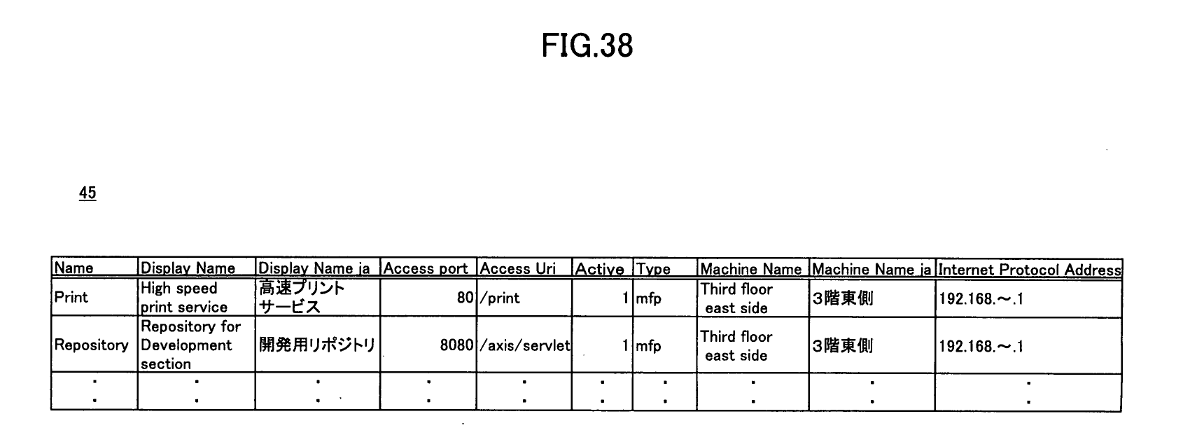

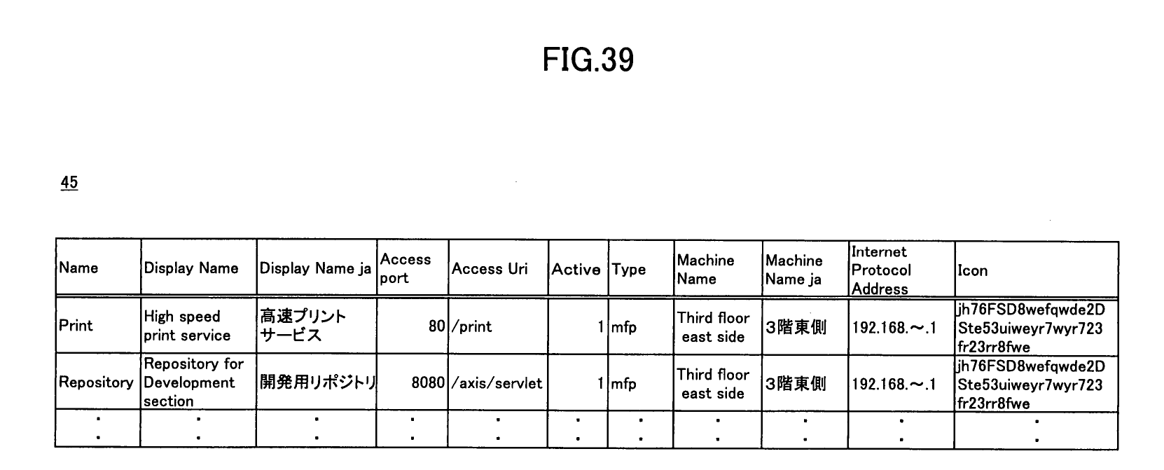

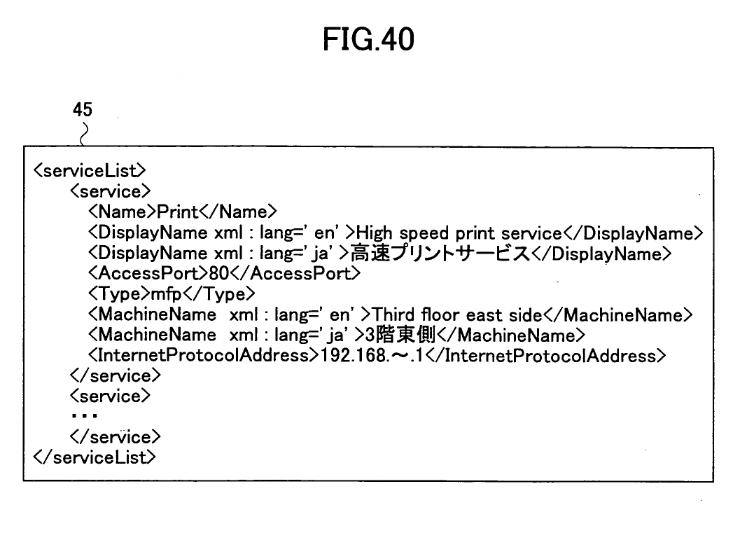

Details of the service information storing part 45a will be described with reference to FIG. 37, FIG. 38, FIG. 39, and FIG. 40.

The operation state determining part 155 refers to a value of “Active”, which will be described later, from the information concerning the service which the service information managing part 154 obtained from the service information storing part 45a, and determines whether the service providing service is in the operate state or in the stop state. Alternatively, the operation state determining part 155 determines based on a search result by the service information managing part 154 whether the service providing service is in the operate state or in the stop state.

The search condition determining part 156 determines whether or not the information concerning the service corresponding to the search condition included in the request sent from the client terminal 20 exists in the information concerning the service obtained from the service information storing part 45a by the service information managing part 154. Alternatively, the search condition determining part 156 determines based the search result by the service information managing part 154 whether or not the information concerning the service corresponding to the search condition included in the request sent from the client terminal 20 exists in the service information storing aprt 45a.

The search condition determination part 156 may determine based on language indication information which is included in the request and analyzed and maintained by the request analyzing part 152 whether or not it is required to respond in Japanese.

The response generating part 153 generates the response including the information concerning the service obtained by the service information management from the service information storing part 45a, and sends the response to the network I/F part 151.

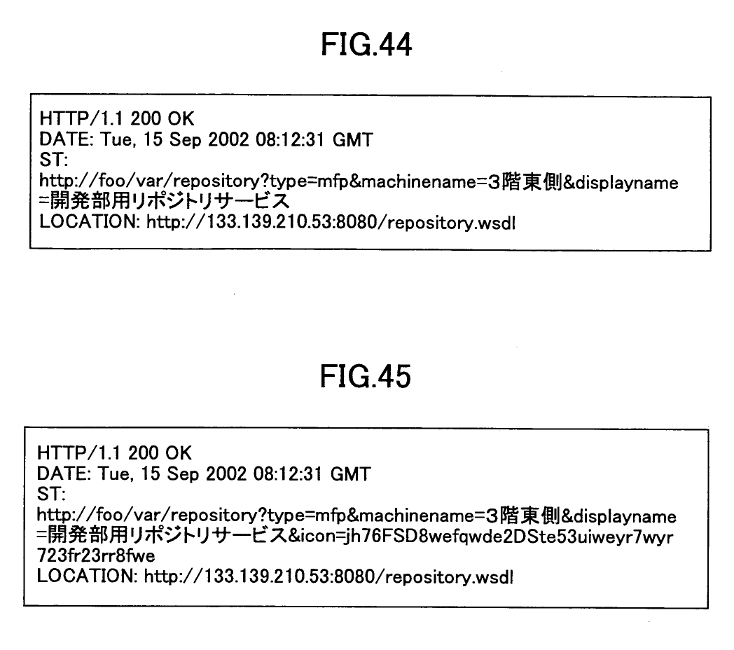

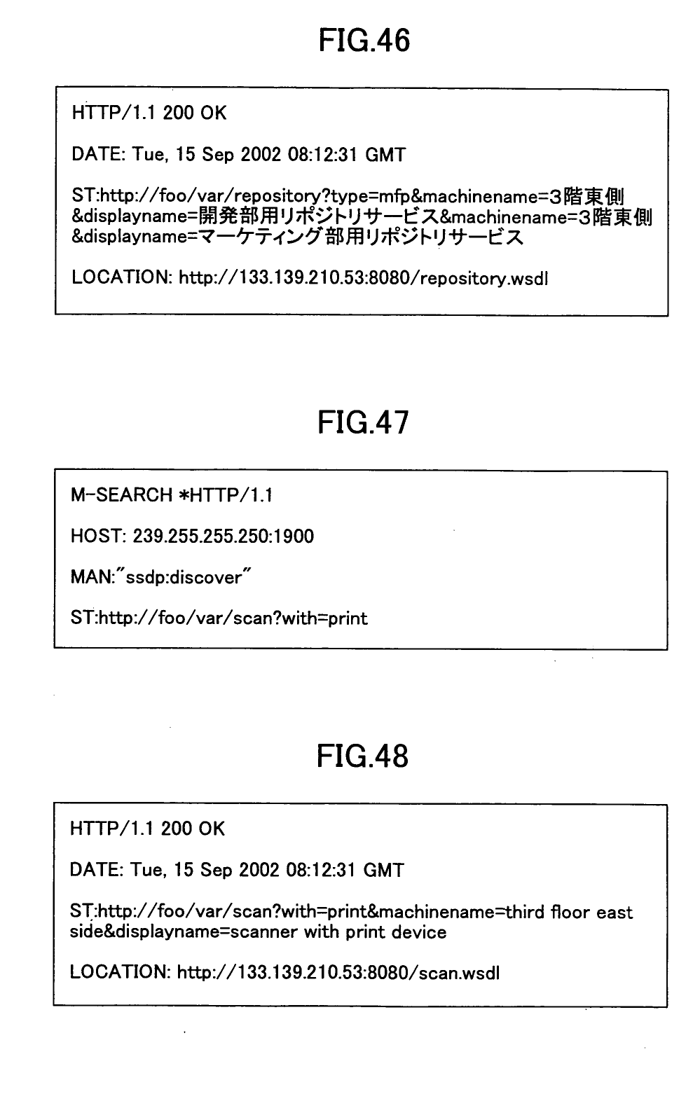

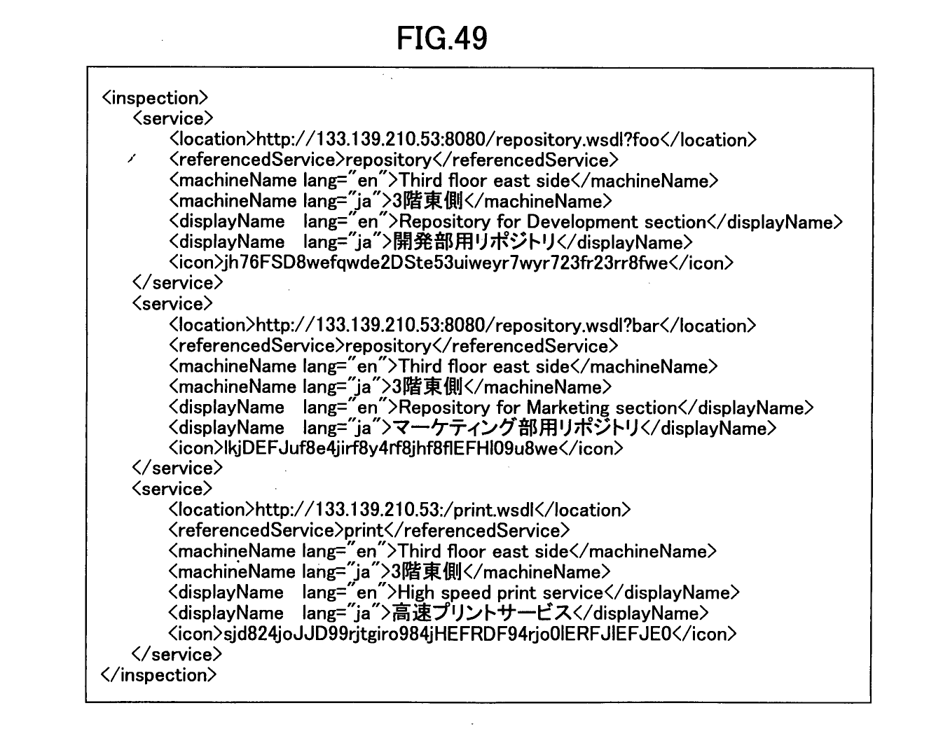

Details of the response will be described with reference to FIG. 42, FIG. 44, FIG. 45, FIG. 46, FIG. 48, and FIG. 49.

FIG. 37 is a diagram for explaining the service information storing part according to the third embodiment of the present invention.

As shown in FIG. 37, the service information storing part 45a includes items of “Name”, “Display Name”, “Access port”, “Access Uri”, “Active”. “Type”, “Machine Name”, and “Internet Protocol Address”.

The item “Name” stores a name of the service.

The item “Display Name” stores a name for a display of the service.

In the item “Access port”, a port number of an end point (indicated by a POST of a SOAP (Simple Object Access Protocol) request) of the Web service is stored.

In the item “Access Uri”, a request URI (Uniform Resource Identifier) of the end point (indicated by a POST of a SOAP (Simple Object Access Protocol) of the Web service. The request URI is positioned after an host description portion of an HTTP URL is stored.

In the item “Active”, a value “1” is stored when the service providing service is in the operation state, and a value “0” is stored when the service providing service is in the stop state.

In the item “Type”, an implementation type of the service is stored. For example, even if the implementation type is identical to a name space of the service, a plurality of the services having a different implementation, purpose, performance, security, and charge are implemented. Thus, the item “Type” is used to distinguish each service.

In the item “Machine Name”, the name of an apparatus providing the service is stored in English.

In the item “Machine Name”, a name of an apparatus providing the service is stored in English.

In the item of “Internet Protocol Address”, an IP address of an apparatus where the service providing service is implemented to provide a service is stored.

In the service information storing part 45a, the information concerning the service managed by the service information providing server 10a is centralized. Thus, the service information providing process 40a can determine the search condition with respect to the request sent from the client terminal 20, generate the response including the name for a display of the service, the implementation type of the service, the name of the apparatus providing the service as shown in FIG. 37, and send the response to the client terminal 20.

The request received form the client terminal 20 will be described with reference to FIG. 41 later, and the response sent to the client terminal 20 will be described with reference to FIG. 42 later.

The client terminal 20 can obtain the response including information needed when the user selects the service, such as the name for a display of the service, the implementation type of the service, the name of the apparatus providing the service, and the like, by sending a single request to the service information providing server 10a.

FIG. 38 is a diagram for emplaning a first variation of the service information storing part according to the third embodiment of the present invention.

As shown in FIG. 38, the service information storing part 45a includes items of “Name”, “Display Name”, “Display Name ja”, “Access port”, “Access Uri”, “Active”, “Type”, “Machine Name”, “Machine Name ja”, and “Internet Protocol Address”.

In the first variation of the service information storing part 45a shown in FIG. 38, different from the service information storing part 45a shown in FIG. 37, the item “Display Name ja”, and the item “Machine Name ja” are additionally included.

In the item “Display Name ja”, the name of a display of the service is stored in Japanese.

In the item “Machine Name ja”, the name of the apparatus providing the service is stored in Japanese.

As described later with reference to FIG. 43, when Japanese is indicated as a language for the information concerning the service to include in the response by the request received from the client terminal 20, the service information providing process 40a generates the response including the name for a display of the service and the name of the apparatus providing the service by writing in Japanese, and sends the response including Japanese to the client terminal 20.

The request indicating the language will be described with reference to FIG. 43 later, and the response including Japanese will be described with reference to FIG. 44 later.

FIG. 39 is a diagram for explaining a second variation of the service information storing part according to the third embodiment of the present invention.

In the second variation of the service information storing part 54 as shown in FIG. 39, the service information storing part 54 includes items of “Name”, “Display Name”, “Display Name ja”, “Access port”, “Access Uri”, “Active”, “Type”, “Machine Name”, “Machine Name ja”, “Internet Protocol Address”, and “Icon”.

In the second variation of the service information storing part 54 in FIG. 39, different from the first variation of the service information storing part 54 in FIG. 38, the item “Icon” is additionally included.

In the item “Icon”, information of an icon concerning the service is stored.

The service information providing process 40a generates a response including the information of the icon concerning the service which is stored in the service information storing part 45a shown in FIG. 39 with respect to the request received from the client terminal 20.

The response including the information of the icon will be described with reference to FIG. 45 later.

In the following, a third variation of the service information storing part 45a will be described with reference to FIG. 40. FIG. 40 is a diagram for explaining the third variation of the service information storing part according to the third embodiment of the present invention.

In FIG. 37 through FIG. 39, the service information storing part 45a illustrated as a relational database (RDB). Alternatively, the service information storing part 45a can be configured as an XML (extensible Markup Language) database (XMLDB). Contents stored in the third variation of the service information storing part 45a are the same as those stored in the first variation of the service information storing part 45a.

FIG. 41 is a diagram for explaining the request according to the third embodiment of the present invention.

In the request shown in FIG. 41, an ID of the service to be searched is described as “http://foo/var/repository” after “ST:” and a search condition is described as “type=mfp” after “?” in a “key=value” format.

The client terminal 20 sends the request including the search condition provided after “?” as shown in FIG. 41, to the service information providing server 10a.

The client terminal 20 can appropriately search for the service corresponding to a request of the user by using the request including the search condition.

The client terminal 20 can indicate a plurality of the search conditions in accordance with a “key1=value1&key2=value2.” format.

FIG. 42 is a diagram for explaining the response according to the third embodiment of the present invention.

In the response shown in FIG. 42, the ID of the service is described as “http://foo/var/repository” after “ST:” and the information concerning the service is described as “type=mfp&machinename=Third floor east side&displayname=Repository for Development section” after “?”.

In detail, the implementation type of the service is described as “type=mfp”, the name of the apparatus providing the service is described in English as “machinename=Third floor east side”, and the name for a display of the service is described in English by “displayname=Repository for Development section”.

In practice, since the response can no include a space, an escape sequence (%20) for an HTTP space character is used, instead of the space. However, for the sake of convenience, the space is included in the response in this embodiment.

Once the service information providing process 40a receives the request as shown in FIG. 41, the service information providing process 40a can generate the response including information needed when the user selects the service such as the implementation type of the service, the name of the apparatus providing the service, and the name, the name for a display of the service, and the like after “?” as shown in FIG. 42, and send to the client terminal 20.

FIG. 43 is a diagram for explaining a first variation of the request according to the first embodiment of the present invention.

In the first variation of the request shown in FIG. 43, “lang=ja” following to “type=mfp&” indicates the language of the information concerning the service to be included in the response corresponding to the request.

In detail, in the request in FIG. 43, “lang=ja” indicates that information corresponding to Japanese in the information concerning the service to be included in the response corresponding to the request should be provided in Japanese by the response.

The client terminal 20 can obtain the information concerning the service described in the language easily understood by the user as the response and provide the information to the user by searching for the service by using the request including language indication information indicating the language of the information concerning the service, which is to be included in the response corresponding to the request, in additional information provided after “?” of the search condition in the request.

FIG. 44 is a diagram for explaining a first variation of the response according to the first embodiment of the present invention.

In the first variation of the response shown in FIG. 44, by “type=mfp&machinename=3 [symbol] &displayname= [symbol] [symbol] [symbol] ”, the information concerning the service is described in Japanese at portions corresponding to Japanese.

In practice, similar to the space, Japanese potions are described in an escape sequence using “%” in the response. However, for the sake of convenience, this embodiment is described by using Japanese characters themselves.

When the service information providing process 40a receives the request as shown in FIG. 43, the service information providing process 40a analyzes a portion “lang=” included in the request in FIG. 43, generates the response including the information concerning the service described in Japanese after “?” as shown in FIG. 44, and sends the response to the client terminal 20.

In the response shown in FIG. 45, the information of the icon concerning the service is described by “icon=jh76FSD8wefqwde2DSte53uiweyr7wyr723fr23rr8fwe”.

The service information providing process 40a can sends the request including the information of the icon that can be easily understood by the user when the user selects the service, with respect to a single request by generating the response including the information of the icon concerning the service shown in FIG. 45.

A third variation of the response will be described with reference to FIG. 46. FIG. 46 is a diagram for explaining a third variation of the response according to the first embodiment of the present invention.

The service information providing process 40a according to the present invention manages a plurality of sets of information concerning a plurality of the service provided the service providing services which are implemented in the service information providing server 10a and other servers. Accordingly, for example, with respect to the request as shown in FIG. 43, the service information providing process 40a can generate the response including the information concerning the plurality of the services.

A third variation of the request will be described with reference to FIG. 47. FIG. 47 is a diagram for explaining the third variation of the request according to the third embodiment of the present invention.

In the request shown in FIG. 47, the ID of the service to be searched for is described by “http://foo/var/scan” following to “ST:”, and the search condition for the service to be searched for is described by “with=print” following to “?”. In FIG. 47., the request is illustrated to search for a scan service which is provided by the same apparatus as the print service.

A fourth variation of the response generated by the service information providing process 40a in a case in which the request as shown in FIG. 47 is received will be describe with reference to FIG. 48. FIG. 48 is a diagram for explaining the fourth variation of the response according to the third embodiment of the present invention.

In the response shown in FIG. 48, information concerning the scan service provided by the same apparatus as the print service is included.

As described in FIG. 41, FIG. 43, and FIG. 47, the client terminal 20 sends the request for searching for the service to the service information providing server 10a and also a GET request of the HTTP 1.1 for obtaining a list of information concerning the services provided by the service information providing server 10a.

A fifth variation of the response with respect to the GET request will be described with reference to FIG. 49.

FIG. 49 is a diagram for explaining the fifth variation of the response according to the third embodiment of the present invention.

In the response shown in FIG. 49, between tags <machineName lang=“en”>and </machineName>, the name of the apparatus providing the service is shown in English.

Between tags <machineName lang=“ja”>and </machineName>, the name of the apparatus providing the service is shown in Japanese.

Between tags <displayName lang=“en”>and </displayName>, the name for a display of the service is shown in English.

Between tags <displayName lang=“ja”>and </displayName>, the name for a display of the service is shown in Japanese.

Accordingly, when the service information providing process 40a receives the GET request sent from the client terminal 20, the service information providing process 40a can obtain the information concerning the services stored in the service information storing part 45a, generate the response including the list of the information concerning the services as shown in FIG. 49, send the response to the client terminal 20.

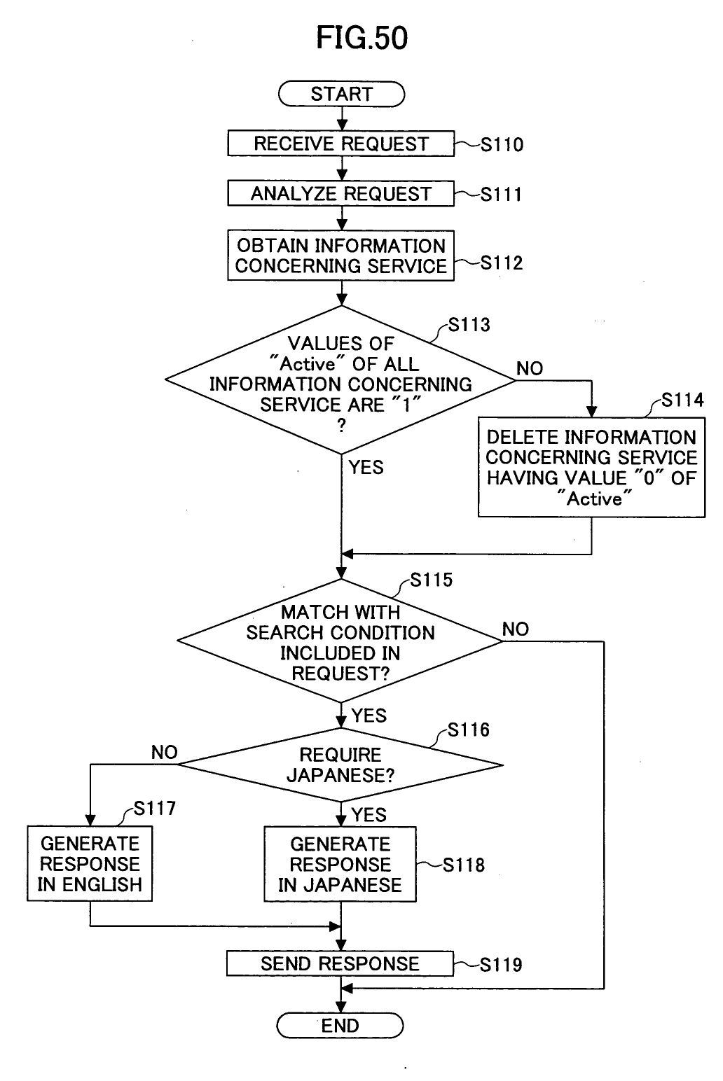

A service information providing process conducted by the service information providing process 40a will be described with reference to FIG. 50 through FIG. 52.

FIG. 50 is a flowchart for explaining the service information providing process according to the third embodiment of the present invention.

In step S110, the network I/F part 151 receives the request for searching for the service as shown in FIG. 41, FIG. 43, or FIG. 47 from the client terminal 20.

In step S111 following to the step S110, the request analyzing part 152 analyzes the request received in the step S110.

For example, the request analyzing 151 analyzes the search condition (type=mfp) described after “?” of the request shown in FIG. 41 and language indication information indicated by “lang=” of the request shown in FIG. 43.

In step S112 following to the step S11l, the service information managing part 154 obtains all information concerning the services from the service information storing part 45a and maintains the information.

In step S113 following to the step S112, the operation state determining part 155 refers to “Active” in all information concerning the services obtained and maintained in the step S112, and determines whether each of the service providing services providing the service is in the operation state or in the stop state.

When the operation state determining part 155 determines that all service providing services corresponding to all information concerning the service obtained in the step S112 are in the operation state (YES of the step S112), the service information providing process advances to step S115. On the other hand, when the operation state determining part 155 determines that at least one service providing service is in the stop state from the service providing services corresponding to all information concerning the service in the step S115 (NO of the step S113), the service information providing process advances to step S114.

For example, the operation state determining part 155 determines that the service providing service which provides the service is in the operation state when a value of “Active” is “1”, and determines that the service providing service which provides the service is in the stop state when a value of “Active” is “0”

In the step S114, the service information managing part 154 deletes information concerning the service which is determined that the service providing service corresponded in the step S113 in all information concerning the service obtained from the service information storing part 45a and maintained in the step S112.

In the step S115, the search condition determining part 156 compares the search condition analyzed in the step S11l with the information concerning the service maintained by the service information managing part 154, and determines whether or not there is information concerning the service corresponding to the search condition in all information concerning the service maintained by the service information managing part 154.

When the search condition determining part 156 determines that there is information concerning the service corresponding to the search condition in all information concerning the service maintained by the service information managing part 154 (YES of the step S115), the service information providing process advances to step s116. On the other hand, when the search condition determining part 156 determines that there is no information concerning the service corresponding to the search condition in all information concerning the service maintained by the service information managing part 154 (NO of the step S115), the service information providing process is terminated.

For example, the search condition determining part 156 compares a value of “type” as the search condition included in the request shown in FIG. 41 with a value of “implementation type” obtained from the service information storing part 45a, and determines whether or not there is the information concerning the service corresponding to the search condition in all information concerning the service maintained by the service information managing part 154.

In step S116, the search condition determining part 156 determines based on a result from analyzing the request in the step S111 whether or not the response is required to be Japanese.

When the search condition determining part 156 determines that the response is required to be Japanese (YES of the step S116), the service information providing process advances to step S118. On the other hand, the search condition determining part 156 determines that the response is not required to be Japanese (NO of the step S116), the service information providing process advances to step S117.

For example, the search condition determining part 156 determines based on the result from analyzing in the step S11l and by checking whether or not the request include “lang=ja” whether or not the response is required to be Japanese.

In the step S117, the response generating part 153 generates the response that does not include Japanese (for example, refer to FIG. 42), by using the information concerning the service maintained by the service information management part 154.

In the step S118, the response generating part 153 generates the response includes Japanese (for example, refer to FIG. 44 or FIG. 45) by using the information concerning the service maintained by the service information managing part 154.

In step s119, the network I/F part 151 sends the response, which is generated in the step S117 or S118, to the client terminal 20 through the network 5.

By conducting the service information providing process shown in FIG. 50, for example, the service information providing process 40a can analyze the contents of the request for searching for the service as shown in FIG. 41, FIG. 43, and FIG. 47, and generate the response as shown in FIG. 42, FIG. 44, FIG. 45, FIG. 46, or FIG. 48 with respect to the request.

In the step S112 in the service information providing process shown in FIG. 50, all information concerning the service is obtained from the service information storing part 45a, and when the value of “Active” is referred to and there is no service providing service being operated, the information concerning the service is deleted. Alternatively, instead of obtaining all information concerning the service from the service information storing part 45a, the information concerning the service is read from the service information storing part 45a by one record and the value of “Active” is referred to, and then, the information concerning the service which the service providing service corresponds to but is in the stop state may be deleted.

Moreover, instead of comparing to the search condition after the information concerning the service is obtained from the service information storing part 45a, for example, by using the search condition included in the request, when the value of “Active” is “1”, information concerning the service where a value of “type” is “mfp” may be obtained from the service information storing part 45a.

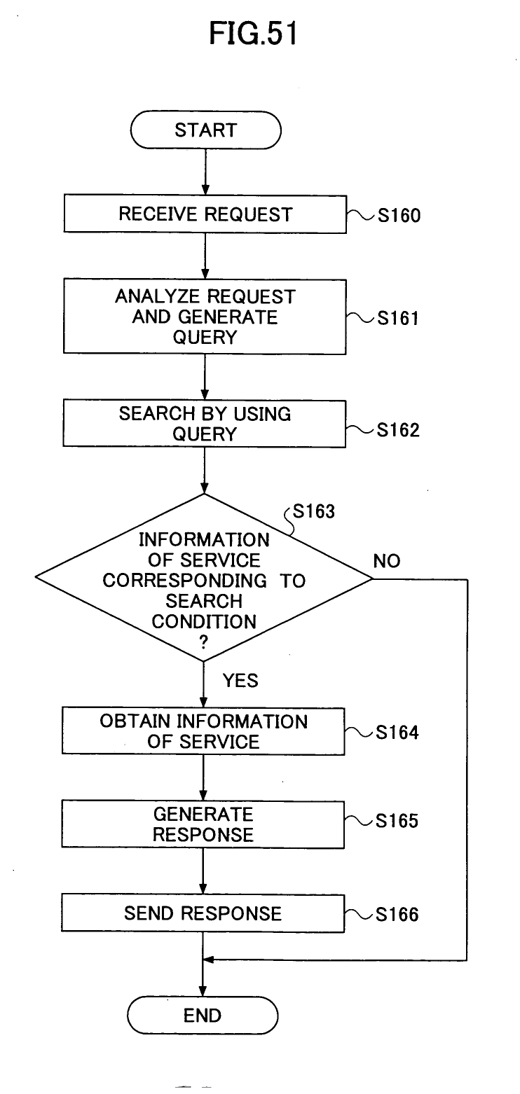

A first variation of the service information providing proves will be described with reference to FIG. 51 in that the information concerning the service corresponding to the search condition is obtained from the service information storing part 45a. FIG. 51 is a flowchart for explaining the first variation of the service information providing proves according to the third embodiment of the present invention.

In step S160, the network I/f part 151 receives the request for searching for the service as shown in FIG. 41, FIG. 43, or FIG. 47 sent from the client terminal 20.

In step S161 following to the step S160, the request analyzing part 51 analyzes the contents of the request and generates a query. The request analyzing part 152 generates the query by using an SQL (Structured Query Language) when the service information storing part 45a is an RDB format as shown in FIG. 37 through FIG. 39. The request analyzing part 152 generates the query by using an XQuery when the service information storing part 45a is an XMLDB format as shown in FIG. 40.

In step S162 following to the step S161, the service information managing part 1.54 executes a search by using the query generated in the step S161, with respect to the service information storing part 45a. For example, the query includes the search condition (type=mfp) described after “?” in the request described in FIG. 41 and the language indication information indicated by “lang=” described in FIG. 43.

In step S163 following to the step S162, for example, the operation state determining part 155 and/or the search condition determining part 156 determines based on a result from the search executed in the step S162 whether or not the information concerning the service matching with the search condition and the like included in the query generated in the step S161 is in the service information storing part 45a.

When the search condition determining part 156 determines that the information concerning the service matching with the search condition included in the query is in the service information storing part 45a (YES of the step S163), the service information providing process advances to step S164. On the other hand, when the search condition determining part 156 determines that the information concerning the service matching with the search condition included in the query is in the service information storing part 45a (NO of the step S163), the service information providing process is terminated.

In the step S164, the service information managing part 154 obtains the information concerning the service required by the request, from the service information storing part 45a. For example, in the request, when Japanese is indicated by “lang=”, the service information managing part 154 obtains information concerning the service that is written in Japanese for the information corresponding to Japanese.

In step S165 following to the step S164, the response generating part 153 generates a response including the information concerning the service obtained in the step S164.

In step S166 following to the step S165, the network I/F part 151 sends the response generated in the step S165 to the client terminal 20.

For example, even if the service information providing process as shown in FIG. 51 is conducted, the service information providing process 40a can generate the response as shown in FIG. 42, FIG. 44, FIG. 45, FIG. 46, or FIG. 48 corresponding to the request for searching for the service as shown in FIG. 41, FIG. 43, or FIG. 47, and send the response to the client terminal 20.

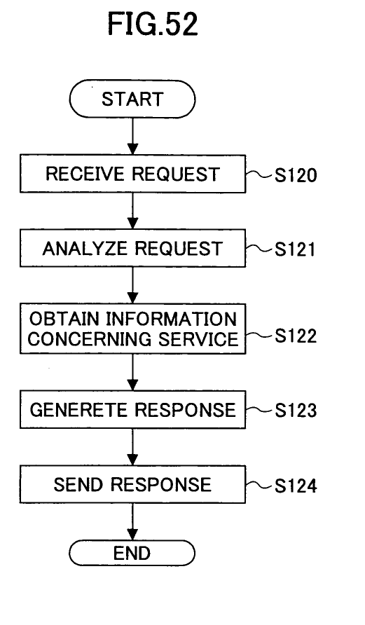

FIG. 52 is a flowchart for explaining a second variation of the service information providing process according to the third embodiment of the present invention.

In step S120, the network I/F part 151 receives the GET request of the HTTP 1.1 sent from the client terminal 20.

In step S121 following to the step S120, the request analyzing part 151 analyzes contents of the GET request received in the step S120.

In step S122 following to the step S121, the service information managing part 154 obtains all information concerning the service from the service information storing part 45a and maintain all information.

In step S123 following to the step S122, the response generating part 153 generates a response including the information concerning the service obtained from the service information storing part 45a in the step S122 (for example, refer to FIG. 49).

By conducting the second variation of the service information providing process, the service information providing process 40a can analyze the contents of the GET request of the HTTP 1.1, and generate the response as shown in FIG. 49 with respect to the request.

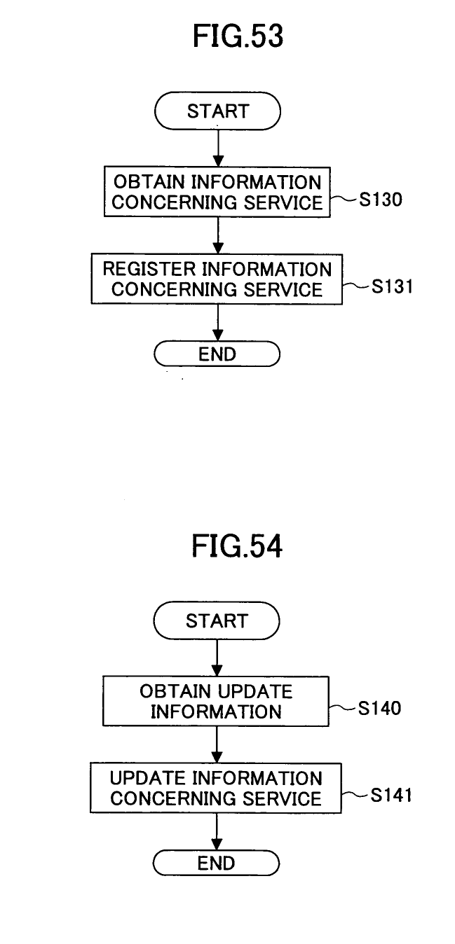

A service information registering process for registering information concerning the service to the service information storing part 45a shown in FIG. 37 through FIG. 40 will be described with reference to FIG. 53.

FIG. 53 is a flowchart for explaining the service information registering process according to the third embodiment of the present invention.

In step S130, the service information managing part 154 obtains the information concerning the service which is provided by the service providing service such as the print service providing service 41 and the repository service providing service 42.

For example, an installer of the service providing service such as the print service providing service 41, the repository service providing service 42, or the like is programmed to send the information concerning the service which the service providing service provide, to the service information providing process 40a. When the service providing service is installed to an apparatus such as a server, the service information managing part 154 obtain the information concerning the service which is installed by the installer of the service providing service.

Alternatively, for example, the service information managing part 154 may send a request for obtaining the information concerning the service to the service providing services such as the print service providing service 41 and the repository service providing service 42 installed in apparatuses being managed, and may obtain the information concerning the service from the service providing service.

Moreover, for example, the service information managing part 154 may obtain the information concerning the service which an administrator managing the service information providing server 10a manually inputs.

In step S131 following to the step S130, the service information managing part 154 registers the information concerning the service obtained in the step S130 to the service information storing part 45a.

By conducting the service information registering process as shown in FIG. 53, it is possible to register the infomraiton concerning the service to the service information storing part 45a.

A service information updating process for updating the information concerning the service stored in the service information storing part 45a shown in FIG. 37 through FIG. 40 will be described with reference to FIG. 54.

FIG. 54 is a flowchart for explaining the service information updating process according to the third embodiment of the present invention.

In step S140, the service infomraiton managing part 154 obtains update information of the information concerning the service stored in the service infomraiton storing part 45a.

For example, the service information managing part 154 obtains the update infomraiton showing that an operation is stopped, from the service providing service such as the print service providing service 41, the repository service providing service 42, or the like.

In step S141 following to the step S140, the service information managing part 154 updates the information concerning the service stored in the service information storing part 45a based on the update information obtained in the step S140.

For example, in the step S140, when the update information showing that the operation is stopped, from the service providing service, the service information managing part 154 changes the value of “Active” corresponding to the service providing service which is sent by the update infomraiton and stored in the service information storing part 45a, from “1” to “0”.

By conducting the service information updating process as shown in FIG. 54, it is possible to update the information concerning the service stored in the service information storing part 45a.

In the third embodiment, the client terminal 20 has the same hardware configuration as that described with reference to FIG. 23, and the explanation thereof will be omitted. Moreover, the client terminal 20 has the same functional configuration as that described with reference to FIG. 24. The same search service selecting screen as that described with reference to FIG. 25 is displayed at the client terminal 20. The same search result screen as that described with reference to FIG. 26 is displayed at the client terminal 20. In the search result screen shown in FIG. 26, the name for a display of the service, the name of the apparatus providing the service are described in Japanese and the icon (representing an MFP) concerning the service is displayed at the client terminal 20.

Accordingly, the user can obtain the information needed when the user selects the service, by using the service information providing server 10a and the client terminal 20 according to the present invention, indicating the service to search for, and conducting a single search.

The same service information obtaining process as that described with reference to FIG. 27 is conducted by the client terminal 20, and the explanation thereof will be omitted.

As an apparatus implementing the service information providing process 40a, the same image forming apparatus for forming an image (hereinafter, called multi-functional apparatus) as that described with reference to FIG. 28 and FIG. 31 can be applied, and the explanations of the functional configuration and the hardware configuration will be omitted.

Accordingly, even if an apparatus implementing the service information providing process 40a is the multi-functional apparatus 1200, the client terminal 20 can generate and send the request for searching for the service (for example, refer to FIG. 41 or FIG. 43) and/or the GET request of the HTTP 1.1 to the multi-functional apparatus 1200. And the client terminal 20 receives the response for searching for the service (for example, refer to FIG. 42, FIG. 44, FIG. 45, FIG. 46, or FIG. 48) and/or the response (for example, refer to FIG. 49) with respect to the GET request of the HTTP 1.1. Therefore, it is possible to provide information needed when the user selects the service, by a single request for searching for the service.

According to the present invention, it is possible to promptly provide information needed when the user selects the service desired by the user.

Moreover, according to the present invention, it is possible to promptly obtain information needed when the user selects the service desired by the user.

According to the third embodiment, the service providing apparatus according to present invention can be realized by installing or downloading a computer-executable program for causing a computer to provide information concerning a service utilized when a user selects the service, the program including the code for managing first information concerning a plurality of service providing parts providing the service and second information concerning the service which is provided the plurality of service providing parts, respectively.

Moreover, a service utilizing terminal according to the present invention can be realized by installing or downloading a computer-executable program for causing a computer to utilize service provided by a service providing part, the program including the code for (a) generating a request including a search condition concerning the service; and (b) receiving a response including information concerning the service, the information utilized when the user selects the service.

The present invention is not limited to the specifically disclosed embodiments, and variations and modifications may be made without departing from the scope of the present invention.

The present application is based on the Japanese priority applications No. 2003-044589 filed on Feb. 21, 2003, No. 2003-044590 filed on Feb. 21, 2003, No. 2004-38540 filed on Feb. 16, 2004, and No. 2004-38541 filed on Feb. 16, 2004, the entire contents of which are hereby incorporated by reference.

What is claimed is:

1. A service information providing apparatus including a service providing part for providing a service which a user utilizes, wherein said service providing part includes a service information providing part providing information concerning the service, the information utilized when the user selects the service, in response to a request from a user terminal.

2. The service providing apparatus as claimed in claim 1, wherein said service information providing part includes a service information obtaining part obtaining the information concerning the service from a service information storing part storing the information concerning the service.

3. The service providing apparatus as claimed in claim 2, wherein the request includes a search condition, and said service information providing part further includes a determining part based on the search condition whether or not the information concerning the service obtained by said service information obtaining part is information concerning the service required by the request.

4. The service providing apparatus claimed in claim 1, wherein the request includes a search condition, and said service information providing part further includes a searching part searching for information concerning the service from a service information storing part storing information concerning the service based on the search condition.

5. The service providing apparatus as claimed in claim 1, wherein said service information providing part includes a request analyzing part analyzing the request sent from the user terminal.

6. The service providing apparatus as claimed in claim 1, wherein said service information providing part includes a response creating part creating a response including information concerning the service utilized when the user selects the service.

7. The service providing apparatus as claimed in claim 1, further comprising a service information storing part storing information concerning the service.

8. The service providing apparatus as claimed in claim 7, wherein the information concerning the service stored in said service information storing part is written in at least two languages, and
the request includes language indication information indicating a language of the information of the service, the information to be included in a response corresponding to the request.

9. The service providing apparatus as claimed in claim 1, wherein a response corresponding to the request includes at least one of a name of the service, a name of an apparatus providing the service, icon information concerning the service as the information concerning the service.

10. The service providing apparatus as claimed in claim 1, wherein said service providing apparatus is an image forming apparatus forming an image.

11. A user terminal which is to be used by a user who utilizes a service provided by a service providing part, comprising:
a request creating part creating a request including a search condition concerning the service; and
a response receiving part receiving a response including information concerning the service, the information utilized when the user selects the service, the response corresponding to the request.

12. The user terminal as claimed in claim 11, further comprising an image generating part generating an image including the information of the service based on the response received by the response receiving part.

13. A service providing method in a service providing part providing a service which a user utilizes, comprising the step of (a) providing information concerning the service utilized when the user selects the service, in response to a request from a user terminal.

14. The service providing method as claimed in claim 13, further comprising the step of (b) obtaining information concerning the service from a service information storing part storing information concerning the service.

15. The service providing method as claimed in claim 14, further comprising the step of determining based on a search condition whether or not the information concerning the service obtained in said step (b) is information concerning the service which is required by the request,
wherein the request includes the search condition concerning the service.

16. The service providing method as claimed in claim 13, further comprising the step of searching for the information concerning the service from a service information storing part storing the information concerning the service based on a search condition,
wherein the request includes the search condition concerning the service.

17. The service providing method as claimed in claim 13, further comprising the step of analyzing a request sent from the user terminal.

18. The service providing method as claimed in claim 13, further comprising the step of creating a response including the information concerning the service utilized when the user selects the service.

19. The service providing method as claimed in claim 13, wherein the request includes language indication information indicating a language of the information of the service that is to be included in a response corresponding to the request.

20. The service providing method as claimed in claim 13, wherein a response corresponding to the request includes at least one of a name of the service, a name of an apparatus providing the service, a type of the service, and icon information concerning the service as information concerning the service.

21. A service utilizing method for utilizing a service provided by a service providing part, comprising the step of:
(a) creating a request including a search condition concerning the service; and
(b) receiving a response including information concerning the service utilized when the user selects the service, the response corresponding to the request.

22. The service utilizing method as claimed in claim 21, further comprising the step of generating an image including the information concerning the service, based on the response received in the step (b).

23. A computer-readable recording medium recorded with a service providing program for causing a computer to execute a process in a service providing part for providing a service which a user utilizes, said program comprising the code for providing information concerning the service utilized when the user selects the service, in response to a request from a user terminal.

24. A computer-readable recording medium recorded with a service utilizing program for causing a computer to utilize a service provided by a service providing part, said program comprising the codes for:
(a) creating a request including a search condition concerning the service; and
(b) receiving a response including information concerning the service utilized when the user selects the service, the response corresponding to the request.

25. A service information providing apparatus for providing information concerning a service utilized when a user selects the service, said service information providing apparatus comprising a managing part managing first information concerning a plurality of service providing parts providing the service and second information concerning the service which is provided the plurality of service providing parts, respectively.

26. The service information providing apparatus as claimed in claim 25, further comprising a storing part storing the first information and the second information.

27. The service information providing apparatus as claimed in claim 26, further comprising a registering part registering the first information and/or the second information to the storing part.

28. The service information providing apparatus as claimed in claim 26, further comprising an updating part updating the first information and the second information stored in the storing part.

29. The service information providing apparatus as claimed in claim 26, further comprising an operation state determining part determining based on the first information concerning the plurality of service providing parts providing the service stored in the storing part whether or not each of the service providing parts operates.

30. The service information providing apparatus as claimed in claim 26, further comprising a service information obtaining part obtaining the second information concerning the service from the storing part.

31. The service information providing apparatus as claimed in claim 30, further comprising a determining part determining based on a search condition concerning the service included in a request sent from a user terminal whether or not the second information concerning the service obtained by the service information obtaining part is information concerning the service required in the request.

32. The service information providing apparatus as claimed in claim 26, further comprising a search part searching for the second information concerning the service from the storing part based on a search condition concerning the service included in a request sent from user terminal.

33. The service information providing apparatus as claimed in claim 25, further comprising a response generating part generating a response including the second information concerning a plurality of the services, the second information utilized when the user selects a desired service from the plurality of the services.

34. The service information providing apparatus as claimed in claim 25, further comprising one or more the service providing parts.

35. The service information providing apparatus as claimed in claim 25, wherein the service information providing apparatus is an image forming apparatus for forming an image.

36. A user terminal which a user uses to utilize a service provided by a service providing part, comprising:
a request generating part generating a request including a search condition concerning the service; and
a response receiving part receiving a response including information concerning the service, the information utilized when the user selects the service.

37. The user terminal as claimed in claim 36, further comprising an image generating part generating an image including information concerning the service based on the response received by said response receiving part.

38. A service information providing method for providing information concerning a service utilized when a user selects the service, said service information providing method comprising the step of managing first information concerning a plurality of service providing parts providing the service and second information concerning the service which is provided the plurality of service providing parts, respectively.

39. The service information providing method as claimed in claim 38, further comprising the step of registering the first information and/or the second information to a storing part.

40. The service information providing method as claimed in claim 38, further comprising the step of updating the first information and the second information stored in a storing part.

41. The service information providing method as claimed in claim 38, further comprising the step of determining based on the first information concerning the plurality of service providing parts providing the service stored in a storing part whether or not each of the service providing parts operates.

42. The service information providing method as claimed in claim 38, further comprising the step of (a) obtaining the second information concerning the service from a storing part.

43. The service information providing method as claimed in claim 42, further comprising the step of determining based on a search condition concerning the service included in a request sent from a user terminal whether or not the second information concerning the service obtained by the step (a) is information concerning the service required in the request.

44. The service information providing method as claimed in claim 38, further comprising the step of searching for the second information concerning the service from a storing part based on a search condition concerning the service included in a request sent from user terminal.

45. The service information providing method as claimed in claim 38, further comprising the step of generating a response including the second information concerning a plurality of the services, the second information utilized when the user selects a desired service from the plurality of the services.

46. A service utilizing method for utilizing a service provided by a service providing part, comprising the steps of:
(a) generating a request including a search condition concerning the service; and
(b) receiving a response including information concerning the service, the information utilized when the user selects the service.

47. The service utilizing method as claimed in claim 46, further comprising the step of generating an image including information concerning the service based on the response received in said step (b).

48. A computer-readable recording medium recorded with a service information providing program for causing a computer to provide information concerning a service utilized when a user selects the service, said program comprising the code for managing first information concerning a plurality of service providing parts providing the service and second information concerning the service which is provided the plurality of service providing parts, respectively.

49. A computer-readable recording medium recorded with a service utilizing program for causing a computer to utilize service provided by a service providing part, said program comprising the code for
(a) generating a request including a search condition concerning the service; and
(b) receiving a response including information concerning the service, the information utilized when the user selects the service.
